(19) United States
(12) Patent Application Publication
(10) Pub. No.: US 2013/0251590 A1
(43) Pub. Date: Sep. 26, 2013

(54) Peracid/Peroxide Composition, Process for Accurately Making the Same, and Method for Use as an Evaporating Film Anti-Microbial Solution and as a Photosensitizer

(71) Applicants: Jeffry Golden, Creve Coeur, MO (US); Paul Brister, O'Fallon, MO (US); Joan Stader, Ballwin, MO (US)

(72) Inventors: Jeffry Golden, Creve Coeur, MO (US); Paul Brister, O'Fallon, MO (US); Joan Stader, Ballwin, MO (US); Charles Martin, Ellisville, MO (US)

(73) Assignee: BioMed Protect ,LLC, St., Louis (MO)

(21) Appl. No.: 13/383,067

(22) PCT Filed: Sep. 21, 2009
(86) PCT No.: PCT/US2009/057695

§ 371 Date: Nov. 16, 2012

Related U.S. Application Data
(63) Continuation of application No. 12/459,777, filed on Jul. 8, 2009, now abandoned.
Application No. 12/459,777 is a continuation-in-part of application No. 11/329,433, filed on Jan. 11, 2006, now Pat. No. 8,110,538.
(60) Provisional application No. 60/642,819, filed on Jan. 11, 2005.

(51) Int. Cl. A01N 25/30

(52) U.S. Cl. CPC A01N 25/30
USPC 422/24; 424/616; 422/28

(57) ABSTRACT

A method is provided for the microbicidal treatment of a surface such as sanitization, disinfection, sterilization, and decontamination of a surface or object by use of an anti-microbial composition comprising an aqueous solution of peracetic acid and hydrogen peroxide with acetic acid, water soluble polymer containing lactam, and phosphate ester surfactant and little or no stabilizer, and according to the method enhanced microbicidal efficacy is obtained when the composition is applied onto a surface as a thin film wetting the surface so that a shorter contact time for a desired fractional reduction in microbial population is obtained Still further, the compositions comprise photosensitizer for light-activated anti-microbial efficacy.

### CROSS-REFERENCE TO RELATED APPLICATIONS

This application is a continuation-in-part of a pending application Ser. No. 11/329,433, filed on Jan. 11, 2006, based on a provisional application Ser. No. 60/642,819, filed on Jan. 11, 2005, published as a publication number US 2007/0229225 (Oct. 12, 2006), Martin et al, “Peracid/Peroxide Composition and the Use Thereof as an Anti-Microbial and a Photosensitizer.”

### STATEMENT REGARDING FEDERALLY SPONSORED RESEARCH OR DEVELOPMENT

This work was part of a project supported by the Technical Support Working Group under contract DAAD05-02-C-0017. The Federal Government retains Government Purpose Rights, including the right to use, modify, perform, display, release, or disclose technical data in whole or in part, in any manner for any government purpose whatsoever, and to have or authorize others to do so in the performance of a Government Contract.

### APPENDIX

Not Applicable.

### BACKGROUND OF THE INVENTION

1. Field of the Invention

The invention relates to a method for microbicidal treatment such as sanitization, disinfection, sterilization, and decontamination of a surface by use of such compositions as an anti-microbial thin film and also as a photosensitizer for light-activated killing. Further, the invention relates to a process for accurately making storage-stable embodiments of the anti-microbial compositions. This invention still further relates to aqueous anti-microbial compositions, made by the provided process, the compositions comprising peracetic acid, hydrogen peroxide, acetic acid, phosphate ester surfactant, water-soluble polymer containing lactam, and optionally, small amounts of minors and little or no additional stabilizer.

2. Description of Related Art

Compositions comprising aqueous solutions of peracetic acid (peracetic acid) and hydrogen peroxide (HP) as microbicidal active ingredients are well known to have excellent microbicidal efficacy. When used as dilute solutions or as Use Dilutions of concentrated solutions, such compositions can be highly effective sporicides, disinfectants, bactericides, virucides, fungicides, tuberculocides, sanitizers, decontaminants, and mold killers. Such compositions are applied onto surfaces as a wiped, sprayed, or brushed on liquid, as a sprayed, drifted, or electrostatically attracted aerosol, or by immersion such as dipping. By conventional methods, a surfeit of anti-microbial is applied to the surface to thoroughly wet the surface and maintain a wet surface for at least a required period of time, the contact time, to obtain a desired fractional reduction in the targeted microbial population. The desired fractional reduction is commonly expressed as minus the logarithm of the ratio of the surviving microbial population and the initial microbial population and is referred to as the “logs of killing”. Regulatory approval of a product as a sanitizer, disinfectant, sterilant, or decontaminant and approval of efficacy claims made on the label for such a product generally involve the validated achievement of a required number of logs of killing within the contact time stated in the label claim for a specific organism or type of organism.

It is advantageous that the contact time be as short as possible. Advantages of a reduced contact time are the sooner availability for use of the surface or object being treated, or increased productivity of the person, or machine performing the treatment or subsequent related tasks such as post treatment wiping or rinsing, or more reliable achievement of microbicidal efficacy.

A commonly used approach to shorten the contact time is to use an anti-microbial composition with greater concentration of active ingredients so that the product of concentration (C) and contact time (T_{c}), the so-called “CT_{c}” product, is adequate to achieve the required logs of killing with a desired T_{c}. However, use of compositions with greater concentration of active ingredients has the disadvantages of greater cost, greater corrosivity, greater release of volatile organic compounds, potential hazards, and/or toxicity, constraints on shipping, storage, and disposal, and additional hazard warnings and requirements for use of personal protection equipment.

In the microbicidal efficacy testing and development of directions for use of the compositions and Use Dilutions of the compositions of Martin et al, it was found that excellent microbicidal efficacy is achieved with the application of a thin layer of the composition, especially when it is used as a photosensitizes. The objectives of the compositions of Martin et al include low cost and low logistical burden, and so, the compositions of Martin et al are used typically with an application rate of about 40 to 150 ml/m² (that corresponds to a layer thickness of about 40 to 150 μm) for non-porous surfaces and up to about 300 ml/m² for porous surfaces such as textiles and carpets. In the testing of the compositions with standard methods (for example, the Germicidal Spray Test, the AOAC Sporicidal Activity Test, et al.) for microbicidal efficacy in the case without light-activated killing, contact times typically much shorter than the time for evaporation of the thin layer (tₑ) were used, i.e., T_{c}<<tₑ. For the photosensitized case, initial testing also was performed with T_{c}<<tₑ.

However, to obtain regulatory approval as a decontaminant, a modified carrier test called the Surface Sterilization Test (SST) was developed in which a thin layer is applied by spraying a carrier such as a glass Petri dish or aluminum weighing dish having a circular patch or carrier of dried inoculum of test organism or spores. In the early stages of testing and development of the SST, a large variability in the microbicidal efficacy was found. The variability was found to correlate with relative humidity, with the amount of material sprayed onto the carrier, and with the type of dish. Further, study of the evaporation rate of a thin layer of the compositions also depended on the type of dish. It turned out that the dependence on the type of dish was because of the flatness of the dish and how level it sat on a lab bench. With the glass dish having a slightly upward convex bottom and the aluminum diSh having a slightly concave bottom, the excess applied liquid flows to the depression at the perimeter of the bottom of the glass dish but puddle at the center of the aluminum dish. From this it was surmised that the sprayed layer thickness for the glass Petri dish carriers at the inoculum was consistently less than the uniform thickness layer expected for a level, flat-bottomed dish. As expected, it was seen that acceptable efficacy only resulted with complete wetting of the inoculated area and that the evaporation time depends on the relative humidity and the thickness of the film that remains after the excess liquid has flowed away, but surprisingly, it was found that the efficacy depended non-linearly on the ratio T_{c}/tₑ. As a consequence, it is found that a greater CT, can be obtained with an evaporating layer of the composition of the instant invention for which T_{c}/tₑ is a substantial fraction of unity than for an essentially non-evaporating or slowly evaporating layer of the composition.

As shown by our testing and as expected by common sense, a necessary condition for good microbicidal efficacy in an unconfined space is that the inoculated surface is completely wet so that the microbicidal composition contacts the target microbes. To ensure that there is an adequate amount of microbicidal composition present on the surface for the necessary contact time, a surfeit of microbicidal composition is applied by common practice because application of a thinner film is likely to lead to film defects of imperfect wetting or dry spots resulting from surface tension effects or patches that dry more quickly and so, the required CT is not Obtained in such places. Though the addition of a substantial amount of thickeners or gels to the composition or the embodiment of the composition as a foam may hold the active ingredients in contact with surface, with such compositions, even with a collapsing foam, the benefits of increased concentration of the active ingredients in an evaporating thin layer are not accrued. Moreover, such use of thickeners and film formers lead to increased viscosity that make application of a thin film by aerosol spraying or wiping more difficult. Further, such additives and amounts result in undesirable amounts of residue.

In contrast to the case of a surface in an unconfined space, there may not be a requirement of thorough wetting for a surface in a confined space because evaporated active ingredients can contact the microbes as a vapor or as a condensate and good microbicidal efficacy can be obtained in spite of the lack of a film entirely wetting the contaminated surface. However, vapor or condensate for microbicidal efficacy does not provide anti-corrosive ingredients to protect the surface from the corrosive active ingredients. This is in contrast to the application of a liquid anti-microbial composition that contains an anti-corrosive ingredient. Thus, the method for microbicidal treatment of a surface of the instant invention applies to the case where the surface is in a space, either confined or not confined, an example of an unconfined space being the outdoors, and where, the relative humidity, is sufficiently less than 100% so that the applied thin layer significantly evaporates during the contact time.

In comparative testing of compositions comprising peracetic acid, hydrogen peroxide, acetic acid, phosphate ester surfactant, and, optionally, water-soluble polymer that differed only by the choice of water-soluble polymer or the absence or water-soluble polymer, it has been shown by the instant invention that compositions comprising water-soluble polymer having a lactam, such as the compositions provided by Martin et al, result in superior microbicidal efficacy to compositions with other polymers or no polymer.

This result is surprising, because it has been reported extensively that the amount of hydrogen peroxide that complexes with the polyvinyl pyrrolidone (PVP) containing lactam is only about 40% by weight of polymer. Thus, for a composition containing about 4% hydrogen peroxide and 0.1° A w/w of PVP, the complexed amount of hydrogen peroxide is only about 0.04% by weight of the composition and only about 1% of the hydrogen peroxide. Yet, the combination of phosphate ester anionic surfactant and water soluble polymer containing lactam in the microbicidal composition is found to be particularly well-suited to the method for microbicidal treatment with an evaporating film and outperforms other polymer and surfactant combinations.

Prior art teaches the use of rheological modifiers, in particular polymer, of which PVP is one, and further that such stabilizers may be anti-corrosive and even for ‘stabilizing’, but only Martin et al teaches the selection of polymer containing lactam and surfactant for their ability to form adducts/complexes, and to improve microbicidal efficacy. For example, U.S. Pat. No. 6,080,712 to Revell et al teaches use of aliphatic alcohol ethoxylates as thickeners. U.S. Pat. No. 6,436,445 to Hei et al teaches polymer thickeners, e.g., methyl cellulose and many related polymers, and synthetic petroleum-based water soluble polymers, which include PVP among many others. U.S. Pat. No. 5,294,644 to Login teaches use of lactams for complexing and for thickener for phosphate esters and for obtaining a highly polar and hydrophobic pyrrolidone moiety for anionic interactions, but not for improved microbicidal efficacy. U.S. Pat. No. 6,403,547 to Grippaudo et al teaches a process of cleaning carpets with a composition comprising peroxygen bleach and an N-vinyl polymer (0.01 to 10% preferably 0.05-2%).

Grippaudo teaches a composition further with a surfactant, preferably an anionic surfactant (or a zwitterionic surfactant or a mixture thereof, most preferably a sarcosinate surfactant) and organic and inorganic acid, with preferred organic acids being acetic acid or citric acid or a mixture thereof and preferred inorganic acids being sulfuric acid or phosphoric acid or a mixture thereof. Particularly preferred inorganic acid is sulfuric acid. Typical levels of such acids, when present, are from 0.01% to 1.0% by weight, preferably 0.05% to 0.08%, and more preferably from 0.1% to 0.5% by weight of the total composition. A preferred peroxygen bleach is hydrogen peroxide. Suitable preformed peroxyacids include diperoxydodecandioic (DPDA), magnesium perphthalatic acid, et al, (but Grippaudo et al. does not mention peracetic acid), and surfactants (anionic, nonionic, zwitterionic, amphoteric, and cationic and mixtures thereof). Suitable anionic surfactants include sarcosinate surfactants, alkyl sulfate surfactants, alkul sulphonate surfactants, alkyl glycerol sulfate surfactants, and alkyl glycerol sulphonate surfactants (but Grippaudo et al. does not mention alkyl ethoxylate phosphate esters).

US 2004/0241110 by Lee describes a jelly-type tooth bleaching patch that uses hydrogen peroxide or other peroxides (including tetra sodium pyrophosphate peroxide) as bleach and PVP-peroxide+stabilizers (including stannate). Various polymer-peroxide combinations are described, including polyvinyl pyrrolidone-vinyl acetate-hydrogen peroxide (PVP-VA-HP), polyvinyl pyrrolidone-acrylic acid-hydrogen peroxide (PVP-AA-HP), as coating forming agents, which may be aided by use of compounds such as methyl cellulose inter alia. U.S. Pat. No. 6,462,008 B1 to Ortiz teaches detergent compositions comprising photobleach delivery systems in which hydrophobic photobleaches are combined with certain water-soluble polymers, which include copolymer of PVP and polyvinylimidazole (PVPVI), and most preferably PVP with an average molecular weight of from 20,000 to 60,000. U.S. Pat. No. 6,472,360 to Beggs et al teaches a multi-part thickenable non-spray of at least two liquid partial compositions each having a viscosity of 20 mPa-s (cP) or less, one part containing peroxygen bleach, and after mixing, final composition having a viscosity of 50 mPa-s (cP) or greater. U.S. Pat. No. 6,183,807 to Gunman et al. teaches use of anionic surfactants including alcohol alkoxylates have ethylene oxide (EO), propylene oxide (PO), and butylenes oxide (BO) blocks, with straight chain primary aliphatic alcohol alkoxylates being particularly useful as sheeting agents. By Gutzman et al, alcohol ethoxylates found to be useful are those having the general formula R-(EO)m-(PO)n, wherein m is an integer of about 2-10 and n is an integer from about 2-20. R can be any suitable radical such as a straight chain alkyl group having from about 6-20 carbon atoms. Gutzman et al. further teaches that compounds such as mono, di and trialkyl phosphate esters may be added for the suppression of foam, with such phosphate esters being produced from aliphatic linear alcohols, there being from 8 to 12 carbon atomics in the aliphatic portions of the alkyl phosphate esters, and alkyl phosphate esters possessing some antimicrobial activity in their own right to add to the overall antimicrobial activity of a composition. U.S. Pat. No. 6,165,483, U.S. Pat. No. 6,238,685, and U.S. Pat. No. 6,627,593 to Hei et al. teach antimicrobial compositions having active oxygen compounds including hydrogen peroxide, isolated peracids, such as peracetic acid inter alia, and anionic surfactants including alkyl, aryl, or alkaryl phosphate esters inter alia, and further, U.S. Pat. No. 6,436,445 to Hei et al teaches the use of water soluble thickener, which may include PVP, although other polymers that have non-Newtonian viscosity are preferred in contrast to PVP that has Newtonian viscosity, to give viscous solutions. U.S. Pat. No. 6,514,556 to Hilgren et al. also teaches peracid and peroxide with surfactant and thickener, with non-ionic surfactants and natural gums, polysaccharide-based, cellulosic polymers, polyacrylates, and hydrocolloid thickeners being preferred. U.S. Pat. No. 6,518,307 to McKenzie et al teaches a method for control of microbial populations in the gastrointestinal tract of animals that uses a peracid composition having a wetting agent, stabilizing agent, and/or a defoaming agent. Among the taught defoaming agents are phosphate esters. U.S. Pat. No. 5,130,124 to Merianos et al. teaches a stabilized, aqueous, film-forming antimicrobial composition of hydrogen peroxide that is stabilized in an aqueous-polyol solvent system containing PVP. U.S. Pat. No. 5,200,189 to Oakes et al. teaches alkyl mono-di-, and tri-phosphate esters to suppress tram and that may be antimicrobial in their own right. U.S. Pat. No. 5,344,652 to Hall I I et al. teaches a hydrogen peroxide and peracetic acid microbicidal composition with a wetting agent containing polyphosphonic acid compounds that may also act as an anti-corrosive.

However, none of the prior art teaches the combination of water-soluble polymer containing lactam and phosphate ester surfactant in a very dilute peracetic acid solution for use as an evaporating thin film microbicidal treatment. In the prior art, the polymer, when used as a thickener, results in a substantial increase in viscosity, which is in contrast to the thin film application to a surface required by the instant invention and provided by the compositions of Martin et al. For example, the compositions used with the instant invention have viscosity about 10 to 50% greater than water in contrast to the thickened compositions of the prior art that have viscosity in the range of several times to many times that of water. Moreover, though alkyl phosphate ester surfactant has some antimicrobial properties, there is no motivation to combine with water soluble polymer containing lactam for the purpose of obtaining improved microbicidal efficacy in an evaporating thin film treatment. Still further, when such compositions in the prior art are used for photoactive processes, the polymer taught as a thickener is specified as one of high molecular weight, which is not desirable for the microbicidal treatment method of the instant invention, nor is it desirable for the process to make a storage stable composition or for the resulting composition of the instant invention.

Thus, by the instant invention, an improved method is provided for the anti-microbial treatment of a surface or object. Moreover, when the anti-microbial liquid is applied with a wipe or comparable applicator that is wet with the composition and so forms an evaporating thin layer that completely wets the surface according to the instant invention, and the wiping dislodges or removes some of the microbes from the surface, the results of the combination of removal of microbes and microbicidal action is superior efficacy with a short T_{c} and a further reduction of the microbial population on the surface. For such a purpose, a wipe that is packaged as a pre-wetted wipe is particularly attractive for its convenience and the speed that it enables with the reduced T_{c}. For such a pre-wetted wipe, the anti-microbial composition in the form of a ready-to-use (“RTU”) solution is especially useful and desirable.

Ready to use (“RTU”) formulations of anti-microbial compositions are desired for several reasons. These include convenience, case of use, safety, ship-ability, and broader market applications. Because excellent microbicidal efficacy can be obtained, with concentrations of active ingredients that are relatively small, namely, hydrogen peroxide less than 8% weight by weight (w/w) and peracetic acid less than 1% w/w, RTU compositions comprise very dilute solutions of peracetic acid. Such very dilute solutions avoid the handling of more concentrated solutions to prepare a “Use Dilution” solution, and they are easier to store and transport. The very dilute, solutions further avoid the common prohibition against shipping by air a concentrate that contains more than 8% hydrogen peroxide. Very dilute RTU compositions are attractive because they pose low risk, greater ease of use, can be used in non-professional settings such as home use, and can be shipped without the constraints that may be applied to more concentrated compositions such as risk mitigation measures such as extensive personal protective equipment, spill containments and countermeasures, mixing equipment and protected and ventilated storage locations that enable the storage, handling, and mixing of more concentrated compositions.

There are several desirable characteristics of microbicidal compositions that depend on the concentrations of the active ingredients of the composition and on the concentrations of additional components that are necessary to obtain the desired characteristics. Of particular interest are the following characteristics:
(1) microbicidal efficacy (ME)
(2) rheological properties such as ability to wet a surface, especially when applied as a thin film by spraying or wiping, e.g., with a wet wipe, spray-ability, ability to penetrate porous materials, and in regard to the instant invention, the ability to consistently and completely coat a surface for CT, enhancement as an evaporating thin film
(3) speed, i.e., a small contact time to obtain a desired level of ME
(4) storage stability
(5) material compatibility, i.e., low corrosivity
(6) efficiency, which can be quantified by the amount of the microbicide that must be applied to obtain a desired level of ME.

(7) aesthetic features, i.e, attributes such as acceptable odor and little or no environmentally non-persistent residue after use, and in particular, after drying
(8) robustness, which is effectiveness in the presence of organic materials and soil (“organic load”) on environmental surfaces, and
(9) shippable within regulatory constraints for transport by commercial means of various modes.

Storage stable, commercially available compositions with hydrogen peroxide and peracetic acid can be categorized by their concentration of peracetic acid. Relatively concentrated products have peracetic acid concentration greater than about 25%, with about 30-35% being typical. There are less concentrated products with peracetic acid concentration of about 15%. Still less concentrated are products with peracetic acid of about 5%. Although all of these compositions may be called dilute solutions of peracetic acid, they are corrosive and are diluted still further with water to make “Use Dilution” solutions for their use as microbicides.

One reason for such concentrated commercial embodiments is that for the microbicidal treatment of a given surface area, the quantity of concentrate material to be shipped is substantially less than for the Use Dilution or an RTU embodiment with concentration equivalent to the Use Dilution. Another reason is that Use Dilutions and RTU solutions comprising compositions with peracetic acid concentration less than about 1% have not exhibited sufficient storage stability for regulatory approval and practical commercial shelf life because small changes in the concentrations of hydrogen peroxide or acetic acid in such compositions, especially by loss, reaction with the container, or degradation, can lead to a relatively large fractional reduction in the peracetic acid concentration, and moreover, the peracetic acid is reactive and is also susceptible to decomposition and reactions with the container, so, as a result, the composition may no longer be in compliance with regulatory requirements for active ingredient concentrations.

The prior art does not offer a storage stable RTU composition comprising a very dilute solution comprising hydrogen peroxide in concentration in the range of 2 to 8% weight/weight (w/w) and peracetic acid in concentration in the range of 0.05 to about 0.74% w/w as active ingredients, which has all of the desired characteristics listed above. Furthermore, there is no such storage stable RTU composition in the prior art for use as a photosensitizer for very rapid photo-activated and photo-killing. Further, in addition to storage stability, RTU compositions as very dilute solutions still may be corrosive, and they may be subject to regulatory constraints on the mode of shipping and packaging volumes, though lesser constrains than for more concentrated compositions.

Much prior art has been directed to overcoming these undesirable properties and providing storage stable and reduced corrosivity compositions with peracetic acid concentration greater than about 1% w/w that can be shipped in commercially useful amounts and modes. In contrast to these more concentrated compositions, Martin et al teaches an RTU embodiment as a very dilute solution that has all of the desired characteristics except that no method for making a stable storage RTU microbicidal composition is given.

Peracetic acid (also known as peroxyacetic acid) in aqueous solution is necessarily found as a component with hydrogen peroxide, and acetic acid. Peracetic acid can be formed by reaction of acetic acid and hydrogen peroxide, which, in a reverse reaction are the products of hydrolysis of peracetic acid. Peracetic acid and hydrogen peroxide can be very reactive with trace constituents even in very dilute solutions. Furthermore, while solutions of peracetic acid, hydrogen peroxide, acetic acid, and water can be prepared that have the constituent proportions that correspond to a chemical equilibrium between the formation and hydrolysis reactions, such solutions are generally unstable, especially in the presence of trace amounts of contaminants in the solution or because of interaction between constituents of the solution and the container for the solution.

Compositions with peracetic acid concentration<1 bio, and especially those with concentration<0.5%, generally have poor storage stability in contrast to more concentrated compositions. The formation reaction and hydrolysis reaction rates generally depend on the concentration of hydrogen ion [H⁺]. Concentrated peracetic acid solutions have low pH, i.e., abundant [H⁺], and so, chemical equilibrium or near equilibrium can readily be obtained for compositions for which the formation rate is in balance with the rates of hydrolysis and other destruction/loss reactions. However, in the case of a very dilute peracetic acid solution, or more concentrated compositions that are buffered to raise pH, the formation and hydrolysis reaction rates may become slow. Also, reactions involving other ingredients to the composition, which are added to achieve certain desired properties, may greatly alter the reaction rates and the rate of approach to equilibrium. Such ingredients include sequestrants, stabilizers, chelators, which are added as stabilizers to one or more of the components used to make the dilute solution, anti-corrosives, surfactants (surface active agents), or rheological modifiers such as polymer, or they may be inadvertent additives as contaminants such as transition metals, halides, and organics. The effect of one or more of these additional components can make unstable a very dilute peracetic acid solution that is initially prepared at or near equilibrium. The consequence is poor storage stability.

The prior art describes several different approaches to obtain storage stability for dilute solutions. These approaches include (1) compositions comprising concentrates Wherein component losses and degradation amount to an acceptably small fraction of the active ingredients, i.e., the ingredients that are the principal active microbicidal ingredients, (2) compositions that comprise binary components wherein ingredients that might react and lead to poor storage stability are put in separate components for mixture prior to use within the pot-life of the mixture, (3) the use of stabilizers and sequestrants to sufficiently overcome the effects or prevent reactions with trace components such as mono- and divalent metal ions and organic contamination that can react with the active ingredients or components necessary for equilibrium and adversely affect storage stability, and (4) use of very clean ingredients that have sufficiently low concentration of trace metals, organic contamination, salts, etc, so that reactions that lead to degradation occur acceptably infrequently so that the desired storage lifetime is achieved.

These approaches to obtain storage stability have disadvantages of one or more undesirable attributes for the characteristics listed above. More concentrated compositions are more corrosive and have poor material compatibility, and further, there are severe constraints or prohibitions against shipping higher concentration solutions. The use of stabilizers and/or sequestrants may lead to undesirable residue or environmental impact. Further, handling the concentrate for mixing requires appropriate personal protective equipment (PPE), adequate ventilation, and spill mitigation means that are by far more extensive than those required for handling and use of a dilute solution. Binary compositions involve mixing and may involve concentrate that is corrosive or has unacceptable constraints on shipping. The use of very clean ingredients may contribute greatly to stability, but as a sole approach is insufficient for stability of very dilute compositions.

Another approach for storage stability is the addition of stabilizer, e.g., sequestrant that ‘captures’ trace quantities of metals and metallic ions. Storage stability is commonly limited because of the degradation of the active ingredients by interactions with trace quantities of mono- and divalent ions, especially those of transition metals, by interactions with trace quantities of halides and/or with trace quantities of organic contamination, and also because of interactions of one or more of the components of the aqueous solution with the container for the composition. One or more stabilizer compounds are commonly added to sequester the metallic species and an anti-corrosive compound may be added to reduce the interaction of the composition with its container. Several examples have been given above. An additional example is aliphatic alcohol ethoxylate wetting agent which has an EO number of greater than 4 in an amount from 0.1 to 5% w/w (U.S. Pat. No. 5,489,706 to Revell). The sequestrant may also be an anti-corrosive compound. Further, an anti-corrosive compound commonly is also desirable so that the anti-microbial composition will not damage, items that it contacts for microbicidal treatment.

Still another approach is the use of very pure, sometimes called “ultra pure” water, such as de-ionized, reverse osmosis, and filtered water, and ‘clean’ ingredients in the production of the peracetic acid and hydrogen peroxide solution so that only an insignificant concentration of undesirable chemical species is present that may lead to degradation or decomposition of the active ingredients or acetic acid that participates in the equilibrium reactions of such compositions (for example, U.S. Pat. No. 5,508,046 to Cosentino).

A different approach to reduce the corrosive effects and the shipping constraints and to obtain storage stability is the formulation of the composition as an equilibrium or near-equilibrium solution with sufficiently small concentrations of active ingredients to reduce shipping constraints and to employ a sufficient amount of stabilizer to obtain storage stability (see for example, U.S. Pat. No. 5,656,302 to Cosentino). However, when such compositions are very dilute solutions, they are difficult to make with accurately achieved and storage stable concentrations of the active ingredients, in particular, the concentration of the peracetic acid. Accurately achieved concentrations and storage stability are of special importance when such very dilute solutions are incorporated in products packaged as pre-wetted wipes, which include pre-saturated wipes.

Generally, the minimum requirement for storage stability is a relative change of less than 10% in the concentration of the microbicidal active ingredients in the course of a year. In some jurisdictions a larger change during the approved shelf-life of the product is permitted, e.g., a relative change in peracetic acid of up to about 30% and relative change in hydrogen peroxide of up to about 10% in a year or longer, e.g., in three years.

Storage stable compositions in the prior art and in commercially available products have a concentration of peracetic acid that typically is greater than 1% w/w and contain stabilizer with concentration greater than about 0.5%, e.g., inorganic phosphate (U.S. Pat. No. 5,077,008 to Kralovic, U.S. Pat. No. 5,624,634 to Brougham, U.S. Pat. No. 5,767,308 to Thiele), polymeric molecularly dehydrated phosphates (U.S. Pat. No. 2,590,856 to Greenspan), pyro-phosphate (U.S. Pat. No. 4,320,102 to Dalton), ortho-phosphate, phosphonate, phosphonic acid (U.S. Pat. No. 5,130,053 to Feasey), including organic phosphonic acids (U.S. Pat. Nos. 4,051,058 and 4,051,059 to Bowing, U.S. Pat. No. 6,028,104 to Schmidt) or their salts, an example being 1-Hydroxy Ethylidene-1,1-Diphosphonic Acid (HEDP) CAS No. 2809-21-4, or ethylenediaminetetracetic acid (EDTA) or its sodium salt, or pyridine carboxylate (see for example, U.S. Pat. No. 5,656,302 to Cosentino, Zhao, et al., and Dul'neva et al.). For typical dilute solutions with peracetic acid concentration in the range of about 5 to 15% w/w, a Use Dilution comprising a 5-fold to 100-fold or greater dilution will have stabilizer concentration that is less than 0.1%. However, for a very dilute composition with peracetic acid concentration less than 1% w/w, especially one that is an RTU solution, a stabilizer concentration greater than about ¼% may lead to an unacceptable amount of residue, in particular when the stabilizer is a phosphate or phosphonate compound that may have adverse environmental impact. Thus, the prior art does not provide very dilute RTU compositions that are storage stable for one or more years and that have low stabilizer content, i.e., less than about ¼% w/w.

Martin et al teaches the benefits of dilute anti-microbial compositions comprising an aqueous solution of peracetic acid and hydrogen peroxide with anionic surfactant and water soluble polymer containing PVP with a lactam (“PVP/lactam”). The benefits include superior efficacy by comparison with compositions not containing anionic surfactant and PVP/lactam, good material compatibility, i.e., low corrosivity, and use as sterilant, disinfectant, sanitizer, and decontaminant. The composition comprises a photosensitizer for light-activated killing of microbes and also an effective microbicide without the light activation. As a concentrate nominally comprising about 24% hydrogen peroxide and 1.2% peracetic acid, a 6-fold dilution made by mixing one part of the concentrate with 5 parts of water results in a Use Dilution solution with about 4.2% active ingredients that has been shown to be a superior sterilant, disinfectant, sanitizer, sporicides, bactericide, virucides, fungicide, mold-killer, photosensitizer disinfectant, and photosensitizer sporicidal decontaminant.

As a very dilute RTU composition according to Martin et al comprising about 4 to 5% hydrogen peroxide and about 0.2 to 0.3% peracetic acid with an equilibrium amount of acetic acid, microbicidal properties that are comparable or superior to the Use Dilution are obtained. However, it is found that the use of any of the common stabilizers described above, for example, phosphonate, inorganic phosphate stabilizer, phosphonic acids or their salts, HEDP, EDTA, et al. in an amount greater than about 0.5% w/w leads to an adverse interaction of the stabilizer with the anionic surfactant and polymer containing PVP with a lactam. The adverse interaction leads to the formation of a flocculent or precipitate and a loss in the microbicidal efficacy, anti-corrosion, and wetting/thin film-forming benefits of the composition containing the anionic surfactant and polymer. As a consequence, the preparation of a very dilute RTU composition of Martin et al cannot use stabilizer such as phosphonate or inorganic phosphate stabilizer with concentration of about 0.5% or greater to obtain storage stability.

The preparation of a storage stable, very dilute RTU composition of Martin et al has previously posed a challenge because small errors in the proportions of the hydrogen peroxide and acetic acid ingredients can lead to unacceptably large errors in the equilibrium concentration of peracetic acid. Moreover, the incompatibility and undesirability of inorganic phosphate, phosphonate, phosphonic acid stabilizer and the like at concentration greater than 0.5% makes the composition susceptible to minor trace amounts of metal ion contamination. The preparation is also made complicated by the prior art's lack of or conflicting quantitative knowledge of the effect of a trace quantity acid catalyst and stabilizer on the rates for the reactions that determine and influence the chemical equilibrium of the composition. Further, slow interactions of the ingredients with container material and loss of one or more component compounds can shift the equilibrium or quasi-equilibrium concentrations of the components of the composition to values that are outside of the regulatory acceptable limits. Such interactions may include evaporation and permeation, and may be exacerbated by “vented” or incompletely sealing caps.

Still further, the prior art does not disclose unambiguous equilibrium constant values and does not teach ingredient proportions for the reliable and consistent preparation of storage stable, very dilute RTU compositions. An accurate value of the equilibrium concentration quotient K_{c} for very dilute compositions was not known because compositions of the prior art contain stabilizers and acid that apparently alter the equilibrium balance between peracetic acid formation and hydrolysis, so, the compositions of the prior art appear to have different values of K_{c} (see, for example, U.S. Pat. No. 5,767,308 to Thiele, Dul'neva et al., and Zhao et al).

Dilute aqueous peracetic acid solutions comprise mixtures of peracetic acid (CH₃COOOH, a.k.a. PAA), water (H₂O), acetic acid (CH₃COOH, a.k.a. AcOH), and hydrogen peroxide (H₂O₂, a.k.a. HP). Commonly, such solutions also contain a small amount of acid catalyst; the most common being sulfuric acid. The acetic acid+hydrogen peroxide react as a “forward” reaction (also, the “formation” reaction) with reaction rate K₁, to form peracetic acid and water, which undergo a hydrolysis reaction as a “reverse” reaction with reaction rate K₂, i.e.,

CH₃COOH+H₂O₂ [symbol] CH₃COOOH+H₂O.

The equilibrium constant K₀ for the reactions is the product of the equilibrium concentration quotient, K_{c}, and the activity constant quotient, Γ_{act}, i.e.

$${K}_{0} = \frac{{K}_{1}}{{K}_{2}} = {K}_{c} {Γ}_{act} .$$

Effective reaction rates k₁ and k₂ can be defined that include the effect of dependence of the activity coefficients on concentration so that the ratio of the effective reaction rates is equal to the equilibrium concentration quotient, i.e.,

$${K}_{c} = \frac{{k}_{1}}{{k}_{2}} = \frac{[ PAA ] [ {H}_{2} O ]}{[ HP ] [ AcOH ]} ,$$

where [x] is the molar concentration of species “x”, PAA means peracetic acid, HP means hydrogen peroxide, and K_{c} will vary with the ionic strength of the solution.

Ideally, equilibrium means that the ingredients to the reaction are in proportions so that the concentrations of the individual reactants do not change in time. In practice, there are additional reactions so that ideal equilibrium is not achieved, or there are differences in concentration from equilibrium so that equilibration proceeds, but a condition of near-equilibrium exists for which the temporal changes are sufficiently slow that the composition meets practical use, storage, and regulatory requirements.

However, a storage stability challenge is posed by equilibrium or near-equilibrium very dilute aqueous compositions with a water mole fraction that is greater than or equal to about 0.91 and with peracetic acid concentration less than 1% w/w and more concentrated dilute solutions for which the ratio of peracetic acid concentration and hydrogen peroxide is less than about 0.15, because small changes or errors in the concentration of hydrogen peroxide and/or acetic acid can lead to large changes in the concentration of peracetic acid. Such errors in concentration may result from the difficulty of accurately measuring peracetic acid concentration in a very dilute solution having a concentration of hydrogen peroxide that is much greater than the concentration of peracetic acid. Changes in concentration may result from degradation of one or more ingredients, especially the degradation of hydrogen peroxide by reactions catalyzed by transition metal ions or halide ions, and it may also result from a loss of water and other constituents from the composition, for example, by evaporation or permeation. Moreover, the peracetic acid is reactive and it is also susceptible to decomposition and reactions with the container and impurities. Thus, the storage stability of such compositions has been elusive, especially for compositions containing little or no stabilizer. As a consequence, the prior art has not adequately provided such storage stable compositions and methods for their preparation.

Regulatory requirements for the storage stability of products comprising peracetic acid-hydrogen peroxide solutions constrain the concentration of the active ingredients to remain, for the duration of the shelf-life of the product, within a range that is defined by a lower certified limit and an upper certified limit. The value of the range depends on the jurisdiction of the regulatory agency. Typically, for compositions with hydrogen peroxide between about 1% and 8% w/w, the allowable range in hydrogen peroxide concentration may be ±10% w/w of the nominal value, and the allowable range for the peracetic acid concentration may be in a range from ±5% to ±30% w/w of the nominal value.

Although some prior art teaches compositions with peracetic acid concentration less than 1%, such very dilute compositions do not exhibit acceptable storage stability for one year or more. An example of such a very dilute composition is provided by Cosentino (U.S. Pat. No. 5,656,302, Table 1), which has an initial equilibrium concentration quotient K_{c} of about 1.4 and comprising about 0.055% w/w peracetic acid, about 1% w/w hydrogen peroxide, and about 5% w/w of acetic acid, but this composition contains about 0.5% or greater concentration of phosphonic acid stabilizer and within a few days of Mixture, the peracetic acid concentration is found to rise substantially and K_{c} to rise to nearly 2. In the course of 193 days, the peracetic acid concentration has nearly doubled to more than 0.9% w/w, and K_{c} is greater than 2. Therefore, the composition of Cosentino's example in his Table 1 does not represent a storage stable equilibrium, nor does it have K_{c} of about 1.4 at room temperature. Thus, Cosentino does not provide for a storage stable very dilute composition with little or no stabilizer and also having phosphate ester surfactant in combination with water soluble polymer containing lactam.

Moreover, the prior art does not provide a process for making a composition with sufficient accuracy so that the concentrations in a composition produced in a batch can be selected and obtained so that upon transferring the batch material to product packages, for example, smaller containers, that the shift in composition can be offset with the effects of evaporation, permeation, and interactions of the composition with the container.

Prior art teaches formation of peracetic acid and water as products of the reaction of acetic acid and hydrogen peroxide or acetic anhydride and hydrogen peroxide. Once formed in aqueous solution, the equilibrium is a balance of the forward formation reaction and reverse reaction of hydrolysis of peracetic acid.

Crommelynck (U.S. Pat. No. 4,297,298) teaches a method of making a dilute, storage stable solution containing a rated concentration between 1 and 20% by weight of an aliphatic carboxylic peracid. In his method, the composition made by preparing a concentrated solution of aliphatic peracid from the corresponding carboxylic acid or anhydride and hydrogen peroxide in a concentration of between 60 and 90% in the presence of the substantially minimal amount of strong acid catalyst necessary to obtain equilibrium of the system in a maximum period of 48 hours; and diluting the concentrated solution of aliphatic peracid, prepared in the preparing step, with a solution containing at least one of the reagents used in the said preparing step in an amount and concentration sufficient to bring the concentration of the aliphatic peracid at least to the rated concentration of the mixture. This method involves very concentrated initial reagents and substantial dilution by which it is very difficult to accurately achieve peracetic acid concentration much less than 1% w/w. Moreover, the concentrated initial reagents are not compatible with a prior addition of surfactant and polymer, and so the anti-corrosive benefit to reduce the interactions of hydrogen peroxide, acetic and peracetic acids with the blending vessel are not obtained.

Le Rouzic et al (U.S. Pat. No. 4,743,447) teaches very dilute compositions with 0.01 to 0.04% peracetic acid, 1-8% hydrogen peroxide, preferably about 3%, and an equilibrium amount of acetic acid (0.5 to 1.5%). These compositions are made by direct reaction of hydrogen peroxide and acetic acid. However, the accurate preparation of such compositions is problematic. Moreover, Le Rouzic teaches the optional use of a non-ionic surfactant, and so, a different equilibrium is to be expected for a composition containing anionic phosphate ester surfactant as for the compositions of the instant invention.

Brougham et al (U.S. Pat. No. 5,349,083) teaches a process fir the production of a dilute solution of a lower aliphatic peracid having an equilibrium composition by contacting hydrogen peroxide with a lower aliphatic acid each at each initial high concentrations in an aqueous reaction mixture thereby to rapidly form a reaction mixture rich in the lower aliphatic peracid and diluting the reaction mixture with water and with any required quantities of lower aliphatic acid and/or hydrogen peroxide to reproduce the equilibrium composition of the dilute solution, the process being characterized in that the reaction mixture rich in lower aliphatic peracid is diluted before it has itself reached equilibrium. However, accurate achievement of the desired final concentrations by Brougham's process requires knowing the equilibrium composition and accurately making the necessary dilutions. Brougham's prescription is to predetermine an equilibrating ‘model’ system and making measurements. This process does not provide for account of batching reactions other than the “forward” formation reaction and the “reverse” hydrolysis reaction. In particular, account is not made of the ancillary hatching reactions of decomposition of peracetic acid to acetic acid and oxygen, degradation reactions between the ingredients and the containing vessel, and evaporation, and in particular at an elevated batch temperature. Thus, Brougham's process is not readily used to make a very dilute solution with high accuracy.

DaSilva et al (U.S. Pat. No. 5,358,867) teaches a process for the accelerated production of stable very dilute peracetic acid solutions in equilibrium. DaSilva's process is an alternative to make dilute equilibrium, storage stable solutions of peracetic acid to the process wherein such compositions are made from mixtures of aqueous hydrogen peroxide and acetic acid, or by dilution of more concentrated peracetic acid solutions, which takes a long time because of the low concentrations of the active participating materials. By DaSilva, the process can be accelerated by employing a two step procedure in which a concentrated peracetic acid solution is diluted with water and partially hydrolyzed in the first step, and then the hydrolysis reaction is quenched by addition of hydrogen peroxide in the second step. As with the Brougham process, the DaSilva process does not provide for account of the ancillary batching reactions.

According to DaSilva, stable solutions, in equilibrium, of peracetic acid in low concentrations are considered to be those which contain between 0.05 and 2.5% by weight peracetic acid; 1.0 and 7.0% by weight hydrogen peroxide; 0.01 and 1.5% by weight, often from 0.2 to 1.5% by weight and sometimes up to 1.0% by weight catalyst; 0.01 and 1.0% by weight stabilizer; 0.05 and 5.0% by weight wetting surfactant and the necessary quantities of water and acetic acid. Mineral, sulphonic or phosphonic acids and the derivatives thereof are considered as suitable catalysts. Pyridine carboxylates and derivatives thereof are considered as suitable stabilizers and, finally, alkylaryl sulphonates and the derivatives thereof as suitable wetting surfactants. DaSilva's Example 1 is a solution with about 2.2% peracetic acid and an apparent K_{c} of about 1.77, and Example 2 is a solution with about 0.13% peracetic acid and an apparent K_{c} of about 3.773. No prescription is given to determine the specific equilibrium compositions, the value of K_{c}, or to account for the ancillary batching reactions.

Malone et al (U.S. Pat. No. 5,565,231) teaches that a peracetic acid solution can be prepared by any of the methods known in the art, which generally comprise reacting acetic acid or acetic anhydride solution with hydrogen peroxide, optionally at elevated temperature, and in the presence of strong acid catalyst, together with any desired stabilizers, such as dipicolinic acid and or an organic phosphonic acid such as ethylenehydroxy-diphosphonic acid. As Malone et al is about effective disinfection of sugar solutions with peracetic acid solutions, means are not provided for achieving accurate very dilute equilibrium peracetic acid solutions, which are not necessary for Malone's objects.

Cosentino (U.S. Pat. No. 5,656,302) teaches stable, shippable microbicidal compositions including between about 0.2 to 8% hydrogen peroxide, about 0.2 to 11% peracetic plus acetic acid, 0 to about 1.0% sequestrant such as organic phosphonic acid or its salt and water, and surfactant between 0 and about 1% with the ratio of total acid to H₂O₂ being between about 1.0 and 11. Several examples are given, but the examples are for compositions with water mole fraction less than 0.9 except for the very dilute solution of Table 1. The data of this table are seen by inspection to show that the peracetic acid concentration nearly doubles in 193 clays, and so, the composition does not represent a stable equilibrium or near-equilibrium composition. Further, in spite of the high precision of the data presented by Cosentino, a process for accurately making the composition is not provided.

### SUMMARY OF THE INVENTION

A method is provided for the microbicidal treatment of a surface such as sanitization, disinfection, sterilization, and decontamination of a surface or object by use of an microbicidal composition comprising a very dilute aqueous solution of peracetic acid, hydrogen peroxide, acetic acid, water soluble polymer containing lactam, phosphate ester surfactant, and little or no stabilizer, and according to the method enhanced microbicidal efficacy is obtained when the composition is applied onto a surface as a thin film wetting the surface and subsequently is an evaporating film so that a shorter contact time for a desired fractional reduction in microbial population is obtained because of the increase in the concentration of the microbicidal active ingredients as the water in the composition evaporates from the thin film. The composition may be applied as a wiped, sprayed, or brushed on liquid, as a sprayed, drifted, or electrostatically attracted aerosol, or by immersion such as dipping.

The method for the microbicidal treatment of a surface comprises the step of applying a very dilute peracetic acid solution as a microbicidal composition to form a thin layer that wets the said surface; and the additional steps of contacting the said surface with the said microbicidal composition for a contact time, T_{c}, that is greater than about 20% but less than or equal to 100% of the evaporation time, tₑ, of the thin layer, i.e.,

$$0.2 \leq \frac{{T}_{c}}{{t}_{c}} \leq 1.0 ,$$

and during the contact time the thin layer is evaporating; and after the contact time, the optional step of illuminating the wet said surface with light for photosensitized microbicidal effect; the optional step of rinsing the surface with clean water to substantially remove residue; the optional step of drying the said wet surface with a sterile wipe; and the optional step of air drying the said wet surface.

When tₑ<T_{c}, the method is extended so that after applying the microbicidal composition and contacting the surface for about 100% of the evaporation time, the steps of applying and contacting are repeated one or more times until the cumulative exposure time that is the product of the evaporation time and the number of application steps, Nₐₚₚ, is at least equal to the desired contact time, i.e., Nₐₚₚtₑ≧T_{c}.

In another aspect, the invention is a process for accurately making a batch of a storage stable embodiment of the compositions for use in the above method of microbicidal treatment of a surface, whereby according to the process ingredients comprising a relatively concentrated solution of peracetic acid, hydrogen peroxide, and acetic acid, a relatively concentrated solution of hydrogen peroxide, glacial acetic acid, phosphate ester surfactant, water soluble polymer containing lactam, little or no additional stabilizer, and optionally small amounts of acid catalyst such as sulfuric acid and minors such as fragrance and colorants are combined in a specified order and in precise amounts to form a more dilute solution with peracetic acid at concentration greater than the desired final concentration of peracetic acid and reacted at elevated temperature to obtain with accuracy an equilibrium or near-equilibrium very dilute composition with concentrations of active ingredients that are storage stable within regulatory limits for more than one year.

The process accurately makes a batch of a storage stable microbicidal composition comprising a very dilute peracetic acid solution with the resulting composition having an equilibrium concentration quotient of about

$${K}_{c} \approx 1.4 exp [ 240.7 ( \frac{1}{T} - \frac{1}{293.2} ) ]$$

at a temperature T given in degrees Kelvin and T is between about 283 and about 328 degrees Kelvin and the mole fraction of water of the said resulting composition is greater than about 0.9. According to the process, in the first step,
(1) the target concentrations are selected, these being the concentrations of hydrogen peroxide, peracetic acid, polymer, and surfactant in the resulting composition at a selected hatching temperature in the range of about 40° C. to about 55° C.
   The following steps are:
(2) calculating the target equilibrium concentration of acetic acid in the said resulting composition;
(3) selecting an initial concentration of peracetic acid,
(4) determining by calculation that includes the decomposition of some of the peracetic acid into acetic acid and oxygen and the evaporation of some of the water during the batch process, and optionally, the degradation of some of the peracetic acid, acetic acid, and hydrogen peroxide, the amount of a diluted solution of a more concentrated solution of known composition, designated the peracetic acid stock solution, comprising peracetic acid, hydrogen peroxide, acetic acid, acid catalyst, and water, the amount of glacial acetic acid of known concentration, the amount of an aqueous solution of hydrogen peroxide of known concentration, designated the hydrogen peroxide stock solution, the amounts of surfactant, polymer, and minors, and the amount of de-ionized/reverse osmosis filtered water to be added to the hatch to obtain the target concentrations;
(5) heating about 75% to about 100% of the amount of de-ionized/reverse osmosis filtered water in a clean, passivated blending vessel to the said selected batching temperature and continuously mixing the contents of the said vessel to limit the spatial temperature variation of the said contents to less than about 5° C.;
(6) adding the determined amount of water soluble polymer to and mixing with the said heated water; then
(7) adding the determined amount of surfactant to and mixing with the contents of the vessel; then
(8) adding the determined amounts of hydrogen peroxide solution and glacial acetic acid to and mixing with the contents of the vessel; then
(9) adding the determined amount of peracetic acid solution to and mixing with the contents of the vessel; then
(10) adding the remainder of the said determined amount of water to and mixing with the contents of the vessel; then
(11) maintaining the contents of the vessel at the hatching temperature with less than about 5° C.′ spatial or temporal variation in the temperature of the said contents for a batching time in the range of about 2 to 4 equilibration times; then
(12) measuring the concentrations of hydrogen peroxide, peracetic acid, and optionally acetic acid;
(13) the optional step of adjusting the composition of the blended mixture to obtain the target concentrations;
(14) the optional step of adding one or more said minor ingredients to and mixing with the contents of the vessel;
(15) cooling the contents of the contents of the vessel to a desired temperature or to ambient temperature in a time that is much less than an equilibration time, and optionally adding one or more said minor ingredients to and mixing with the contents of the vessel; then
(16) the optional step of storing the resulting composition in the vessel, or transferring the said contents to another or several vessels, or transferring the said contents to product packages, or transferring the said contents as an ingredient in one or more products.

In another aspect, the instant invention provides the compositions made by the above process and comprising very dilute peracetic acid solutions that are storage stable RTU microbicidal compositions that can be used in the microbicidal treatment of a surface by the method of the instant invention. Further, the compositions made by the above process comprise photosensitizer for light-activated anti-microbial efficacy.

The storage stable, very dilute RTU compositions so made can be used for microbicidal treatment by a variety of application methods such as liquid or aerosol spraying or misting, wiping, pouring, or by immersion of objects into the composition, or, still further, as a photosensitizer, for application as a liquid or aerosol into a volume or onto a surface for subsequent illumination by light, especially ultraviolet light. Anti-microbial uses include use as a sanitizer, disinfectant, sterilant, virucide, fungicide, moldicide, bactericide, decontaminant, and sporicide. The microbicidal compositions also may be used as ingredients in other products to obtain microbicidal efficacy for a liquid aqueous composition. Further, the storage stable, very dilute RTU compositions may be incorporated with application means such as the pre-wetted wipes, e.g., partially or fully pre-saturated wipes, carriers, or applicators, or added at the time of use to such application means. Moreover, the microbicidal composition can be useful for additional purposes such as cleaning, washing, deodorizing, and as preservative. In another aspect, the composition also can be further diluted just prior to use as a sanitizer, sanitizer-cleaner, or other microbicidal application.

Desirable characteristics of the RTU solution include the following:
(1) microbicidal efficacy when applied as a thin film on a surface,
(2) the consistent formation of a thin layer, i.e., a thin film, that thoroughly wets and coats the surface and has enhanced microbicidal effect as an evaporating thin film,
(3) an acceptably minimal and easily removable residue of non-volatile components after evaporation of the film formed by application of the microbicidal composition,
(4) insignificant interference of the microbicidal composition with the removal and collection of soil and pathogens from the surface by the wipe during the wiping action,
(5) storage stability of the RTU solution upon application to the wipe and during packaging and while packaged with the wipe, especially in the context of the relatively large surface area per mass of a wipe for a given package size, and
(6) accurate concentration of the constituents of the very dilute RTU composition after batching so that the regulatory agency allowed range of concentration for an active ingredient can be well exploited to accommodate changes in composition of the very dilute RTU composition during the shelf life of a pre-wetted wipe product item.

The composition can be applied by various means, for example, by aerosol spraying, pouring, painting, brushing, etc, or be applied with a wipe, such as a partially-saturated or saturated pre-wetted wipe, or a wipe wetted just prior to use. Further, the composition may be used as a microbicidal bath for immersion of objects to be treated, or used as a mist, fog, or aerosol spray to kill airborne microbes and/or be used as a fumigant.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 shows the evaporation time 1 hr a uniform liquid layer as a function of relative humidity for various initial layer thickness (bottom) 12.5 μm to (top) 75 μm, for air current conditions that are typical of a ventilated interior room (v˜0.3 m/s and X˜0.3 m);

FIG. 2 shows the evaporation time for a uniform liquid layer as a function of relative humidity for various initial layer thickness (bottom) 25 μm to (top) 100 μm, for air current conditions that are typical of a container undergoing decontamination outdoors in a 7 mph wind (v˜3.2 in/s, X˜1.0 m);

FIG. 3 shows the concentration of hydrogen peroxide in the remaining liquid layer of the composition of Example I (initial concentration is 4.4% w/w) as a function of the evaporated fraction of the initial layer, wherein the boxes are experimental measurements and the curve is a theoretical prediction;

FIG. 4 shows the ratio (solid curve) of the concentration of hydrogen peroxide in the remaining liquid layer and its initial concentration as a function of the evaporated fraction, (percent) and the ratio (dotted curve) of the concentration of peracetic acid in the remaining liquid layer and its initial concentration as a function of the evaporated fraction (percent), wherein the diamonds correspond to the experimental measurements of hydrogen peroxide;

FIG. 5 shows the time integrated product of concentration and time (CT) for an evaporating liquid layer of the composition of Example 1 as a function of TA, (in percent), which is set equal to the evaporated fraction (ξ in %), wherein it is seen that the CT is enhanced about a factor of 1.25 for ξ=25%, about a factor of 2 for ξ=50% and about a factor of 3.3 for ξ=70%;

FIG. 6 shows the log reduction in E. coli on the bottom surface of a 14 mm diameter well of a polystyrene 24 well plate after a 30 second treatment by 40 μL of microbicide at various concentrations of active ingredients, wherein the initial film thickness of microbicide is approximately 150 μm, and the evaporation time is greater than 5 minutes, so very little evaporation occurs and consequently, very little enhancement of active ingredient concentration occurs, wherein the absicissa shown in the figure is the weight percentage of hydrogen peroxide in the composition, wherein the ratio of peracetic acid and hydrogen peroxide is 1:20, and wherein the dashed line is the limit of detection of the measurement (LOD=6.94 logs reduction);

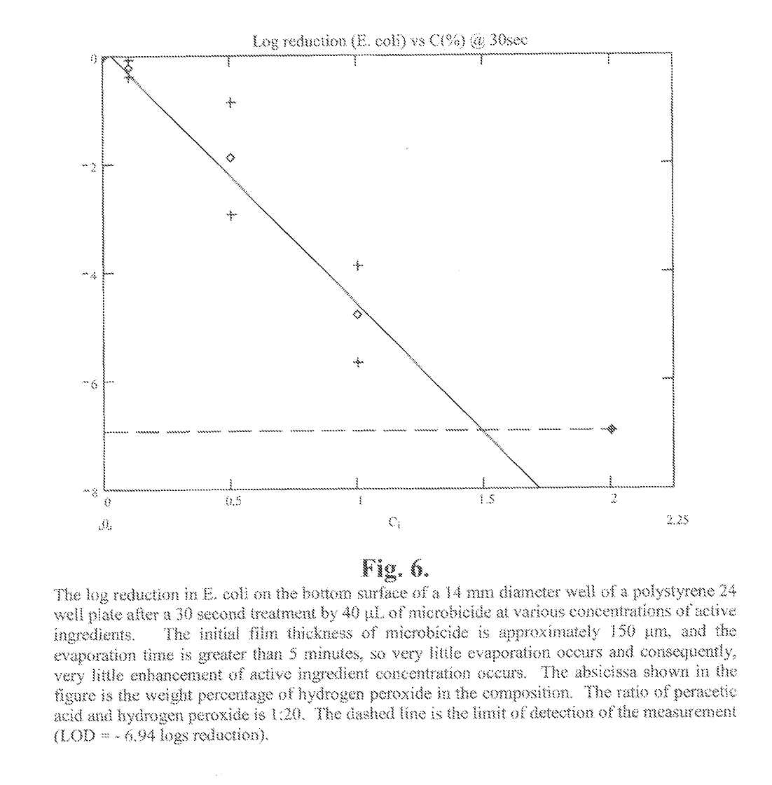

FIG. 7 shows the log reduction plotted as a function of contact time (minutes) for B. subtilis spores dried on a glass Petri dish and treated with microbicide (comprising 4% w/w hydrogen peroxide and 0.2% w/w peracetic), wherein the dotted curve is a regression tit that includes the point at 5 minutes, which corresponds to the limit of detection (LOD 7.28 logs reduction) and wherein the dashed line is a 2^{nd} order polynomial tit to the data points, each of which represents the mean of several tests;

FIG. 8 shows the log reduction of Bacillus atrophaeus spores (bar 1) 4.43 logs, resulting from a 1 minute contact time of the composition of Example I compared to compositions that differ by replacement of the PVP polymer containing lactam with (bar 2) 2.76 logs, PPG, (bar 3) 2.66 logs, PEG, and (bar 4) 2.78 logs, no polymer;

FIG. 9 shows the concentration quotient K_{c} plotted as a function of the mole fraction of water X_{w}., wherein the data points shown with “x” are experimentally measured values from the data of Revell et al., Martin et al., and DaSilva et al. for X_{w}<0.91, and the composition of the instant invention for X_{w}>0.91, wherein curve 1 is a 4^{th} order polynomial tit to the data, wherein curve 2 is a polynomial fit and curve 3 is a local polynomial regression to the data of Cosentino et al, wherein curve 4 is an extrapolation of the data of Sawaki et al., and wherein curve 5 is a curve representing the evolution of the data of Cosentino et al, Table 1 from day 11K₀=1.394 to day 193 (K₀=2.424);

FIG. 10 shows the concentration quotient for Cosentino's Table 1 dilute formulation seen to vary significantly with time, wherein the composition does not appear to be storage-stable;

FIG. 11 shows the concentration quotient for Cosentino's Table 2 formulation is seen to vary significantly with time, wherein the composition does not appear to be storage-stable;

FIG. 12 shows a plot of the concentration quotient K_{c} vs water mole fraction X_{w} for the compositions of Cosentino's Table 2 showing a significant monotonic decrease of K_{c} with increasing X_{w};

FIG. 13 shows a plot of the measured concentration of peracetic acid as a function of time for batches at various temperatures ((boxes) 23°, (diamonds) 45°, and (circles) 55° C.) allowing determination of the equilibration times (7.5, 1.3, and 0.77 days, respectively);

FIG. 14 shows the concentration of peracetic acid as a function of time shown for two batches, each started with the same initial ingredients, wherein one batch (upper curve) was made and stored just above room temperature (23° C.) and the other batch (lower curve) was made and stored at 45° C.;

FIG. 15 shows the w/w concentrations of (upper curve) acetic acid, (middle curve) hydrogen peroxide, and (lower curve) peracetic acid as functions of time (hours) during a hatch process at a temperature of about 55° C., wherein the curves are calculated values and agree with measurement data with a standard deviation of about 3%; and

FIG. 16 shows the predicted concentrations as a function of time shown for the post-hatching equilibration and evolution of the batch of microbicidal composition at room temperature after batching for 60 hours at a temperature of about 55° C. (as shown in FIG. 15), followed by a fast cool down with no added fragrance, and then storage in sealed containers.

### DETAILED DESCRIPTION OF THE INVENTION

The following description of the preferred embodiment(s) is merely exemplary in nature and is in no way intended to limit the invention, its application, or uses.

### Method for Microbicidal Treatment of a Surface

The enhancement of CT, during the evaporation of a thin film of a peracetic acid solution (which necessarily contain hydrogen peroxide, acetic acid, and water) that wets a surface, i.e., a layer of the liquid composition in contact with the surface and wetting the surface, can be explained by the increase in concentration in active ingredients that occurs as the layer evaporates. However, as these active ingredients become more concentrated and become more corrosive, it might be expected that they will react more with the material comprising the surface, with each other, and with the “inerts” in the solution, such as surfactant, polymer, and stabilizers. Further, as their concentration increases, their evaporation rate also will increase significantly, and as a result, their concentrations will increase until the concomitant increasing and limiting reactions and evaporation stop further increase and even lead to decrease in their concentrations as the evaporation of the layer approaches the evaporation time, tₑ, the time at which nearly all of the water in the initial layer is gone from the residual layer.

Surprisingly, it is found that for very dilute peracetic acid solutions that contain phosphate ester surfactant and water-soluble polymer, that the concentration of hydrogen peroxide increases by about a factor of 10, and the concentration of peracetic acid increases by at least a factor of 4, when 90% of the water in an initial thin film has evaporated, i.e., when the evaporated fraction of the initial thin film, ξ, is about 0.9. Further, it is found that little corrosion occurs, even on reactive metal surfaces, and that an apparently contiguous film remains during the evaporation. Still further, evaporating films of such very dilute peracetic acid solutions that contain phosphate ester surfactant and water-soluble polymer containing lactam have superior microbicidal efficacy.

RTU microbicidal compositions and Use Dilutions (i.e., very dilute solutions that are made from more concentrated microbicidal compositions) that have hydrogen peroxide and peracetic acid as their principal active ingredients are typically very dilute aqueous peracetic acid solutions comprising at least peracetic acid, hydrogen peroxide, acetic acid and water. As very dilute solutions, the evaporation rates of the solutes, peracetic acid, hydrogen peroxide, and acetic acid are governed by Henry's Law, for which at the air-liquid interface of the solution the vapor pressure of a solute constituent is equal to the molar concentration of the constituent divided by the product of the relevant Henry's Law constant and the density of the solution (which density is close to 1 kg/liter for very dilute solutions), rather than Rauolt's Law, for concentrated solutions for which the vapor pressure is equal to the product of the saturation vapor pressure for a vapor of the constituent and the mole fraction of the solute in the solution. As a consequence, the solute vapor pressures are small in a very dilute solution, so the solute evaporation rates are small, and the evaporation of a thin film of such a very dilute peracetic acid solution is dominated by the evaporation of water. Moreover, even though the saturation vapor pressures of acetic acid and peracetic acid are about two-thirds that of water for temperatures in the range of 10°-50° C., and the saturation vapor pressure of hydrogen peroxide is an order of magnitude smaller, their vapor pressures given by Henry's Law for very dilute solutions are very much smaller. Thus, when the thin film has evaporated to where ξ approaches about ⅔, the relative evaporation rates of the acetic acid and peracetic acid will be comparable to that of the water.

Knowledge of the evaporation time, tₑ, for a given set of ambient conditions enables the best exploitation of the CT_{c} enhancement of the evaporating microbicidal composition. The evaporation time depends on the relative humidity, RH (in percent), the air speed over the liquid-air interface of the thin film, ν⁰, the scale size for the air flow over the film, X, the ambient temperature, T, and the initial thickness of the film, Δ₀.

In a mildly convective atmosphere, the scale length for the vapor concentration gradient can be calculated as a function of viscosity μ, flow velocity ν⁰, mass density ρₐ, of the atmosphere and the diffusion coefficient D of the evaporating species. Boundary layer thickness δ and local vapor pressure of the evaporating species at the liquid film-atmosphere interface provide a basis for calculating the concentration gradient ∇c, which is such that

$$∇ c \approx \frac{3}{2} \frac{( {c}_{0} - {c}_{∞} )}{{δ}_{c}} , \qquad ( 1 )$$

where

$${δ}_{c} = {δ [ \frac{D {ρ}_{a}}{μ} ]}^{1 / 3}$$

is the concentration boundary layer thickness [see, for example, Cussier], and c₀−c_{∞} is the difference of the vapor concentration c₀ at the liquid-atmosphere interface and the concentration c_{∞} in the atmosphere outside of the boundary layer.

Fick's law is used to calculate the flux, Γ, from the interface,

$$Γ = - D ∇ c = - D \frac{d c}{d x} = - \frac{3}{2} D \frac{{c}_{0} - {c}_{∞}}{{δ}_{c}} , \qquad ( 2 )$$

where x is the distance from the interface. Note that integration of Eqn. (2) and application of appropriate boundary conditions gives the result of Eqn (1). At the interface, the flux is

$${Γ}_{0} = - D ∇ c = - \frac{3}{2} D \frac{{c}_{0} - {c}_{∞}}{{δ}_{c}} . \qquad ( 3 )$$

The calculation of evaporation rate proceeds with a calculation of the volumetric loss rate from a film of thickness Δ(t). Consider an area of film Ã; the corresponding liquid volume is \tilde{V}=ÃΔ(t). The rate of change is

$$\frac{d \tilde{V}}{d t} = {Γ}_{0} {v}_{m s} \tilde{A} , \qquad ( 4 )$$

where νₘₛ is the liquid molecular volume of species s,

$${v}_{m s} = \frac{{M}_{s}}{{ρ}_{s} {N}_{a}} , \qquad ( 5 )$$

and where Mₛ is the molecular weight (e.g., M=0.018 kg/mole for water), ρₛ is for the liquid mass density, and Nₐ is Avogadro's number. For an ideal gas, the number density, i.e. concentration c (or N) is calculated from p=NkT, where k is Boltzmann's constant, and R=Nₐk is the ideal gas constant. Combining Eqns. (3-5) yields

$$\frac{d Δ ( t )}{d t} = \frac{3}{2} \frac{D}{{δ}_{c}} [ \frac{{p}_{∞}}{{T}_{∞}} - \frac{{p}_{0}}{{T}_{0}} ] \frac{{M}_{ s}}{{ρ}_{s} R} ≡ - {K}_{e} , \qquad ( 6 )$$

where T_{∞}=temperature in the air away from the layer, and T₀ is the temperature at the air-liquid interface. Integration gives the time dependent thickness of the layer as,

$$Δ ( t ) = {Δ}_{0} - {K}_{e} t and {t}_{e} = \frac{{Δ}_{0}}{{K}_{e}} , \qquad ( 7 )$$

where Δ₀ is the initial film thickness and tₑ is the evaporation time.

The concentration boundary layer thickness of δ_{c} is calculated as a function of characteristic scale length X of the surface over which the laminar flowing atmosphere has a convective velocity of ν⁰.

$$δ = f ( X , {v}^{0} ) \frac{δ}{X} = {{[ \frac{280}{13} ]}^{1 / 2} [ \frac{{Xv}^{0} {ρ}_{a}}{μ} ]}^{- 1 / 2} . \qquad ( 8 )$$

Consequently, the concentration boundary layer thickness is given by,

$$\frac{{}_{}^{.}{δ}{}_{c}^{}}{X} = {{4.641 [ \frac{μ}{{Xv}^{0} {ρ}_{a}} ]}^{1 / 2} [ \frac{D {ρ}_{a}}{μ} ]}^{1 / 3} . \qquad ( 9 )$$

For air, μ=1.82×10⁻⁵ N-s/m², ρₐ=1.2 kg/m³, and in indoor situations, a typical velocity may be estimated as the result of ventilation, density defects of suspended aerosol, or, more typically, buoyancy as a result of thermal gradient. In outdoor situations, a typical velocity may be estimated as the mean wind speed.

The buoyancy velocity for a room of height Hᵣ and thermal difference LIT is estimated as

$${v}^{0} = \sqrt{2 g \frac{Δ T}{T} {H}_{r}} , \qquad ( 10 )$$

where g(ΔT/T) is a “reduced gravity”, and ventilation flow is assumed to be small. In a typical office, Hᵣ˜2.4 m, ΔT˜½° K, so ν⁰˜0.3 m/s, i.e., the air current is about one foot per second.
For ease of calculations, consider ν⁰=1 m/s, then Eqn. (9) gives δ_{c}/X as,

$$\frac{{δ}_{c}}{X} = 0.73 [ \frac{{D}^{1 / 3}}{{X}^{1 / 2}} ] . \qquad ( 11 )$$

For water vapor in air, D=2.6×10⁻⁵ m²/s at 20° C., and

δ_{c}=0.73D^{1/3}X^{1/2}=0.02163X^{1/2}, (12)

when ν⁰=1 in/s.

For very dilute solutions, the evaporative loss of solutes is governed by Henry's Law,

$$p = [ \frac{{c}_{s}}{{K}_{H}} ] , \qquad ( 13 )$$

where cₛ is the liquid solute concentration (typically in moles/kg) of solute species “s” and K_{H} is Henry's constant (e.g., K_{H}˜745 mole/kg-bar for peracetic acid, K_{H}˜4900 mole/kg-bar for acetic acid, and K_{H}˜1.1×10⁵ mole/kg-bar for hydrogen peroxide). For the solvent, the vapor pressure is given by Raoult's Law, which for very dilute solutions yields p≈pₛ, the saturated vapor pressure of the solvent. For water, the saturated vapor pressure is

$${p}_{ws} = exp \{ 16.7 - \frac{4060}{T - 37} \} kPa , \\ or \\ {p}_{ws} = exp \{ 18.72 - \frac{4062}{T - 37} \} Torr \qquad ( 14 )$$

and at T=293 K, p_{ws}=2.318 kPa.

Relative humidity RH is given in percent and is defined as

$$RH = \frac{p}{{p}_{ws}} 100. \qquad ( 15 )$$

At RH 50%; p=½ p_{ws}=1.159 kPa.

Thus, the characteristic evaporation time for water,

$$\begin{matrix}{τ}_{e 0} = {[ \frac{3}{2} \frac{{D}_{w}}{{δ}_{cw}} \frac{{p}_{ws}}{{T}_{0}} ( 1 - \frac{RH}{100} ) \frac{{M}_{s}}{{ρ}_{w} R} ]}^{- 1} \\ = {\frac{5.611 \times {10}^{6}}{( 1 - \frac{RH}{100} )} [ \frac{X}{{v}^{0}} ]}^{1 / 2} ,\end{matrix} \qquad ( 16 )$$

Where the subscript, “w”, denotes “water”. The corresponding form of Eqn. (7) for the layer thickness as a function of time is given by,

$$Δ ( t ) = {Δ}_{0} ( 1 - \frac{t}{{t}_{c}} ) , \qquad ( 17 )$$

and the evaporation time for the thin film is given by,

tₑ=Δ₀τₑ₀. (18)

Some examples of tₑ can be calculated using Eqn. 18 for the evaporation of a microbicidal composition comprising 4% w/w hydrogen peroxide, 0.2% w/w peracetic acid, and less than 5 w/w acetic acid from a treated surface. For typical conditions on the wall in an office, e.g., ν⁰=0.3 m/s, X=2.4 in, RH=50%, then

τₑ₀≈3.04×10⁷ s/m. (19)

If Δ₀=30 μm, then tₑ≈912 s (≈15 min); for a layer initially twice as thick, t, 30 min. For a typical disinfectant or sanitizer application onto a counter top, an area of about 1-2 square feet might be sprayed or wiped. In this case a typical scale length is about X˜0.3 m, then t_{c}=9.8 min. As a further example, consider a 6 cm diameter Petri dish in a fume hood with ν⁰=0.5 m/s. If the composition is applied by spraying 0.21 nil into the X=6 cm dish, and a layer (film) results with initial thickness Δ(t=0)=75 μm. For RH=50%, Eqn(7) yields tₑ≈4.9 min. The commonly observed value is approximately 5 minutes. With a flow rate of about ν⁰≈10 m/s such as might be achieved with a fan or an intentional flow of gas to accelerate the evaporation, the corresponding evaporation time is tₑ≈min. It is seen from these examples that in many common circumstances, the evaporation time tₑ is in the range of about one to 30 minutes for RH˜50%.

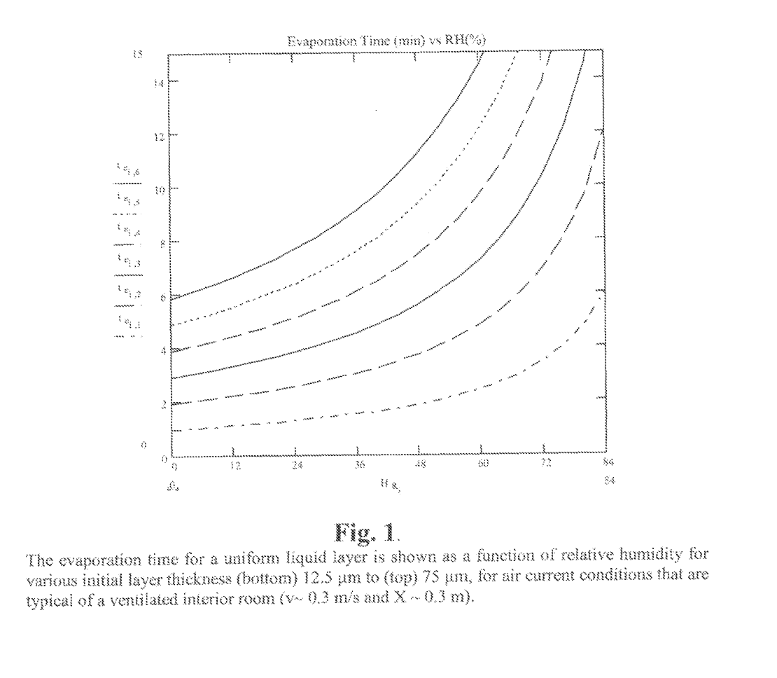

Of particular interest are thin films with initial thickness Δ(t=0) in the range of about 12.5 μm to about 75 μm or in the range of about 50 μm to about 150 μm. The first range is typical of the layer applied by a pre-wetted wipe such being especially useful for the disinfection or sanitizing of interior surfaces in healthcare, residential, commercial, and food preparation settings, and the like. For this initial thickness range, FIG. 1. shows the evaporation time, tₑ, for a uniform liquid layer as a function of relative humidity, RH, for various initial layer thickness (bottom) 12.5 μm to (top) 75 μm, for air current conditions that are typical of a ventilated interior room (v˜0.3 m/s and X˜0.3 m).

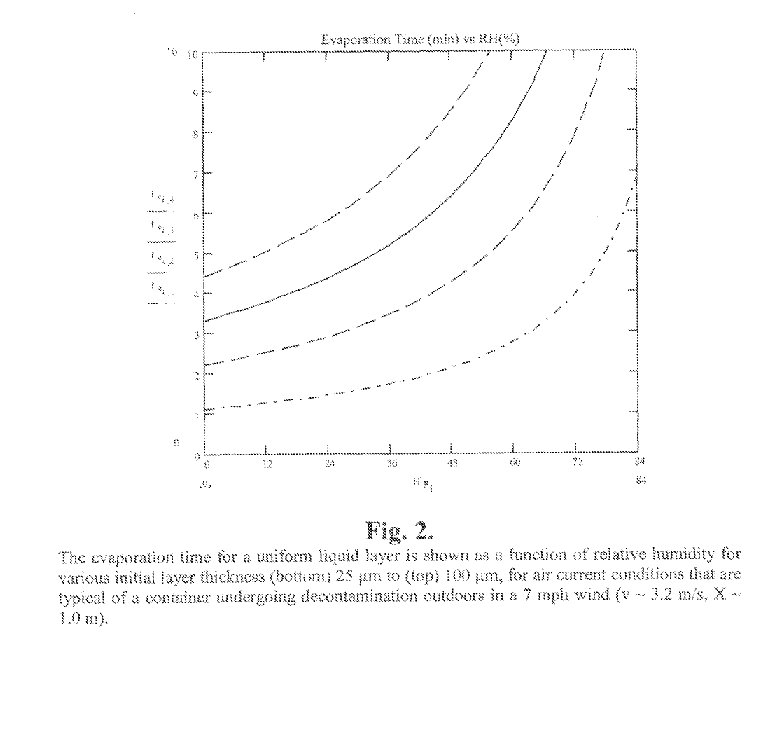

The second range of initial thickness is typical of the layer applied by spraying as an aerosol as being especially useful for larger scale indoor and outdoor applications such as mold remediation, decontamination of biological warfare and bio-terrorism agents, agriculture and food production settings, and the settings listed above. For part of this range, FIG. 2. shows the evaporation time, tₑ, for a uniform liquid layer as a function of relative humidity, RH, for various initial layer thickness (bottom) 25 μm to (top) 100 μm, for air current conditions that are typical of a container undergoing decontamination outdoors in a 7 mph wind (v˜3.2 m/s, X˜1.0 m).

It is found that the active ingredient concentrations increase with evaporation of a thin film by a time (t) dependent factor F(t) that is approximately given by,

$$F ( t ) = \frac{g [ ξ ( t ) ]}{1 - ξ ( t )} , \qquad ( 20 )$$

Where, g[ξ(t)] is a function that depends on the evaporated fraction of the initial layer,

$$ξ ( t ) = 1 - \frac{Δ ( t )}{Δ ( t = 0 )} , \qquad ( 21 )$$

and that accounts for the limiting reactions and shift from Henry's Law to Rauolt's Law. This function is near unity until ξ(t)→1, then g decreases rapidly and limits F(t) to a moderate finite value.

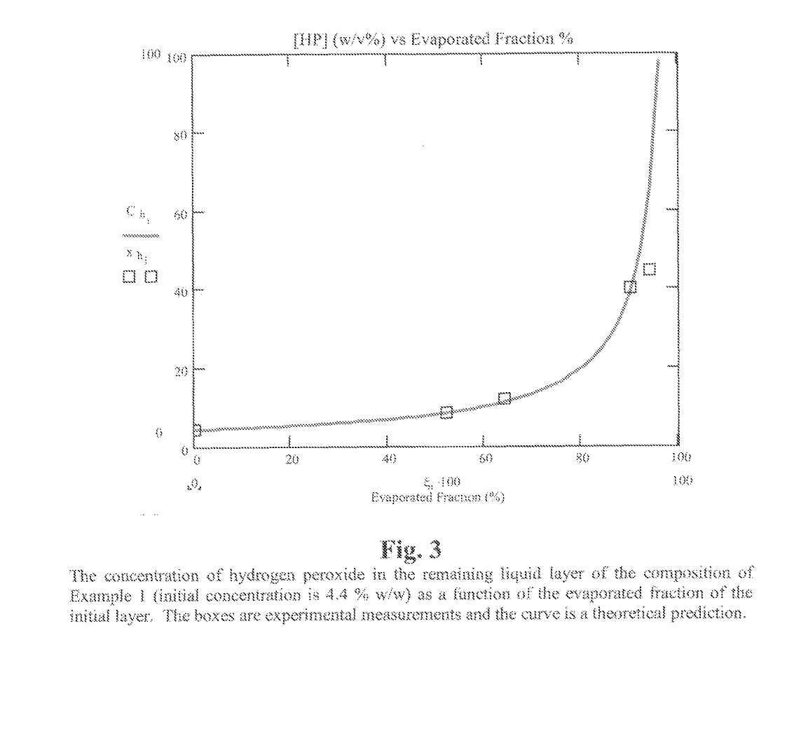

Measurements have been made to determine the change in concentration of the principal active ingredients (hydrogen peroxide and peracetic acid) with the evaporation of microbicidal compositions that are each a very dilute peracetic acid solution comprising about 0.23% w/w peracetic acid, about 4.4% w/w hydrogen peroxide, about 4.9% w/NA, acetic acid, 0.1% w/w phosphate ester surfactant, de-ionized/reverse osmosis (DI/RO) filtered water, and 0.1% w/w polymer selected from the group of lactam containing polyvinyl pyrrolidone (PVP), polyethylene glycol (PEG), and polypropylene glycol (PPG), or with no polymer, minor amounts of stabilizer and sulfinic acid, and with a balance of water. The evaporation was performed in a polystyrene Petri dish to minimize any corrosion reactions between the liquid and the dish. It is found that in all cases, the concentration increases according to Eqn. (20), with the maximum measured increase being about a factor of 11 when ξ(t)=0.95. This is seen in FIG. 3, where the concentration of hydrogen peroxide in the remaining liquid layer is plotted as a function of the evaporated fraction of the initial layer. The boxes are experimental measurements and the curve is a theoretical prediction with g(ξ)=1.

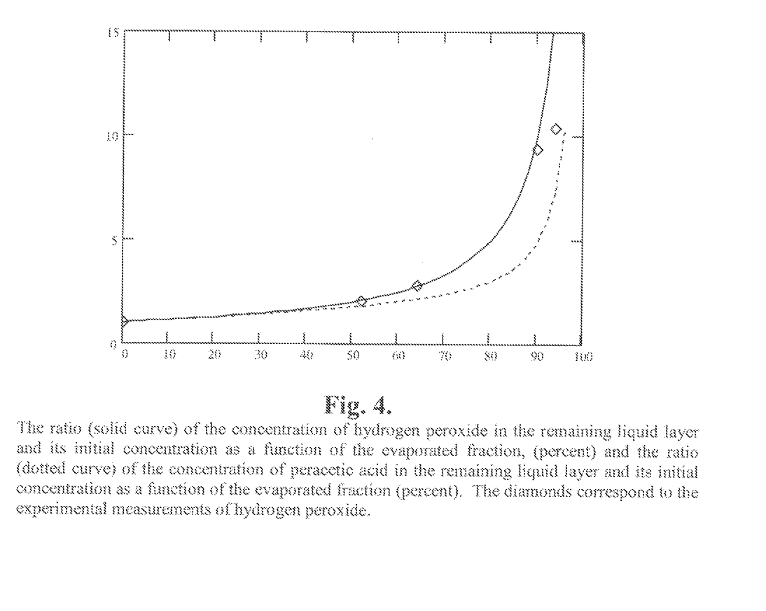

FIG. 4 shows the ratio (solid curve, per Eqn. (20)) of the concentration of hydrogen peroxide in the remaining liquid layer and its initial concentration as a function of the evaporated fraction, ξ (percent), and the ratio (clotted curve, theoretical estimate) of the concentration of peracetic acid in the remaining liquid layer and its initial concentration as a function of the evaporated fraction (percent). The diamonds correspond to the experimental measurements of hydrogen peroxide. Measurement of the peracetic acid in the layer proved to be very challenging. The measurement for the determination of <1% w/w peracetic acid content in a solution with hydrogen peroxide>8% w/w is made difficult by the disparate volumes of titrant required that lead to imprecise end-point determination and the associated loss of peracetic acid because of reactions in a large volume of diluent. Measurement by high performance liquid chromatography (HPLC) was complicated by the large peroxide peak interfering with the peracetic acid determination and by the limited dynamic range of the detector. Consequently, the measured increase in peracetic acid by about a factor of 4.5 for ξ˜0.9 to 0.95 should be considered a lower bound on the actual peracetic acid concentration. Based on an approximate weighting factor to account for the increase in evaporation of peracetic acid as ξ→1, an estimate of the enhancement in peracetic acid concentration is shown as the dotted line in FIG. 4.

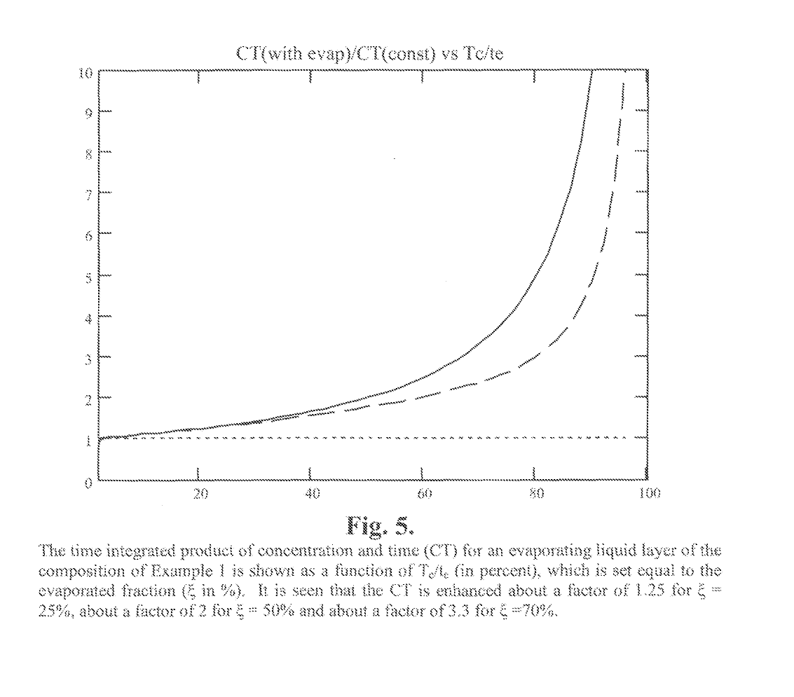

Based on the curves of FIG. 4, a prediction of the increase in the product of concentration, C, and contact time, T_{c}, i.e., the CT_{c} product, can be made. This is shown in FIG. 5, where the time integrated product of concentration and time (CT_{c}) for an evaporating liquid layer of the above composition with PVP polymer is shown as a function of T_{c}/tₑ (in percent), which is set equal to the evaporated fraction in (ξ in %), since by Eqns. 17 and 21, ξ=ttₑ. The solid curve shown in the figure is for hydrogen peroxide, the dashed curve is for peracetic acid, and the dotted curve corresponds to a constant concentration. It is seen that the CT, is enhanced by about a factor of 1.25 for ξ=25%, about a factor of 2 for ξ=50% and about a factor of 3.3 for ξ=70%. With the enhancement, the T, necessary to achieve a desired log reduction, i.e., microbicidal efficacy level, is reduced by a factor that is the inverse of the enhancement in comparison with the T_{c} without the enhancement.

Typically, the log reduction in a microbial population by microbicidal treatment is proportional to CT_{c}. This is illustrated in FIG. 5, where the log reduction in E. coli on the bottom surface of a 14 mm diameter well of a polystyrene 24 well plate after a 30 second treatment by 40 μL of microbicidal composition with PVP polymer, described above, at various dilutions to vary the concentrations of the active ingredients. The initial film thickness of microbicide is approximately 150 μm, and the evaporation time is much greater than 5 minutes, so very little evaporation occurs and consequently, very little enhancement of active ingredient concentration occurs. The abscissa shown in the figure is the weight/weight percentage of hydrogen peroxide in the composition. The ratio of peracetic acid and hydrogen peroxide is 1:20. Because the treatment time, i.e., T_{c}=30 sec, is the same for all dilutions, it is seen that the log reduction decreases linearly with CT_{c}. The dashed line is the limit of detection of the measurement (LOD=6.94 logs reduction).

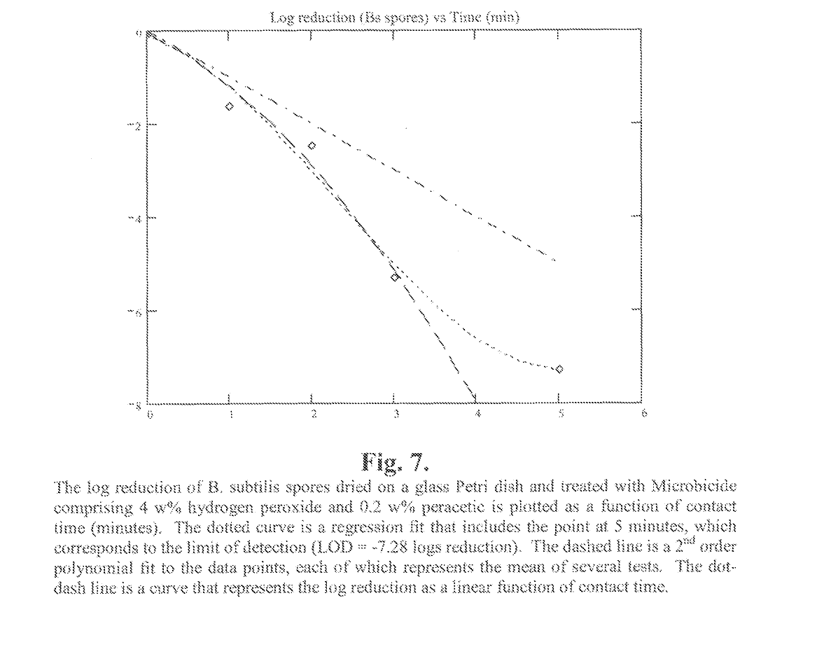

In contrast is the case for the treatment of Bacillus spores with a spray applied thin layer that is evaporating with time. FIG. 7 shows the log reduction plotted as a function of contact time (minutes) for B. subtilis spores dried on a glass Petri dish and treated with the microbicidal composition with PVP polymer (the active ingredients comprising 4% w/w hydrogen peroxide and 0.2% w/w peracetic) The dotted curve is a regression tit that includes the point at 5 minutes, which corresponds to the limit of detection (LOD=7.28 logs reduction). The dashed line is a 2^{nd} order polynomial fit to the data points, each of which represents the mean of several tests. The dotted curve is misleading because the point at 5 minutes is at the LOD, and so distorts the curve. Instead, the dashed curve should be considered to be representative of the temporal dependence. It is seen that the log reduction is not a linear function of time, but instead the rate of microbicidal effect increases with time. Observation shows that the evaporation time for the spray applied microbicidal composition with initial layer thickness Δ(t=0) of about 50 μm is about 5 to 6 min, which agrees with the predicted tₑ shown in FIG. 1 for the RH˜40% that is typical of the laboratory in which the tests were conducted. So, the abscissa of FIG. 7 can be converted to ξ(t) by dividing the time by tₑ˜5.5 min. Also shown in FIG. 7 is a dot-dashed curves that represents the log reduction as a linear function of contact time. Comparison of the ratio of the 2^{nd} order fit curve and the linear function with the enhancement predicted by the curves in FIG. 5, yield the results shown in Table I below. It is seen that there is reasonable agreement of the experimental values with the predicted values.

TABLE 1
Comparison of Experimental and Predicted Enhancement

| ξ(t) in % | Experiment | Prediction |
|---|---|---|
| 18 | 1.22 | 1.21 |
| 36 | 1.45 | 1.56 |
| 55 | 1.72 | 1.90 |

The enhancement in concentration of the active ingredients in an evaporating thin film alone does not lead to enhanced microbicidal efficacy. It is also necessary that the thin film continues to wet the surface as it evaporates. Film defects such as dry spots, for example, those formed by surface tension effects that pull the liquid away from the defect, are areas where the microbicidal composition may no longer be in contact with the target microbe. Thus, the film forming characteristics of the composition are important. Moreover, as taught by Martin et al, the distribution of the actives within the solution may affect the microbicidal efficacy. For example, the formation of adducts and complexes of the active ingredients with the polymer and surfactants, and the association of the polymer and surfactant can affect the efficacy. Thus, the choice of polymer and surfactant has been found to be critical. Further, it is found that these ingredients also play an important role as anti-corrosives, in film-forming and other theological properties, and in storage stability. It is also clear that it is desirable that the composition have sufficiently low viscosity so that is can be readily applied as an aerosol spray or by wiping onto a surface as a thin film. Compositions for which the polymer and/or surfactant lead to a viscosity substantially greater than water will not flow and readily form a thin film. In a preferred embodiment, the viscosity at about room temperature of the compositions of the instant invention is less than about 2 mPa-s (cP), and in a more preferred embodiment, the viscosity is less than about 1.5 mPa-s (cP), and in a still more preferred embodiment, the viscosity is less than about 1.3 mPa-s (cP). By comparison, the viscosity of water at room temperature is about 1.003 mPa-s (cP).

A study was performed with the microbicidal compositions described above that varied only by the choice of polymer. In this study, an inoculum of Bacillus atrophacous spores were dried on a Petri dish and the microbicidal compositions were applied by aerosol spray. After spray application, dry nitrogen gas flowed over the Petri dishes for about ½ minute to accelerate the evaporation of the microbicidal compositions. The apparent evaporation time was about one minute. At one minute, catalase and sodium thiosulfate neutralizer solution was applied to stop microbicidal action. The spore challenge level was approximately 1.9 to 2.2×10⁷ spores and the nominal recovery was about 1×10⁷ spores. Experimental controls included comparison test with neutralization, with no polymer, and with the various polymers, also phosphate buffered saline (PBS) controls, titer determination, and recovery fraction determination. The recovered samples were plated and enumerated on days 1, 2 and 3.

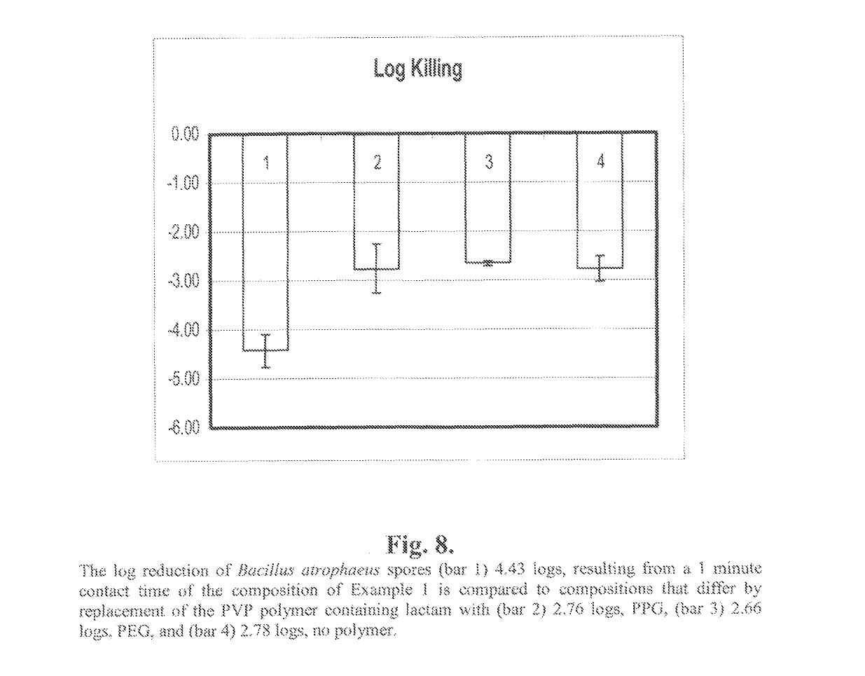

The results of the comparative study are seen in FIG. 8. The log reduction of Bacillus atrophaeus spores by the microbicidal composition with PVP, (bar 1) 4.43 logs, is compared to compositions that differ by replacement of the PVP polymer containing lactam with PPG (bar 2), 2.76 logs, (bar 3) PEG, 2.66 logs, and no polymer (bar 4), 2.78 logs. The microbicidal composition with PVP polymer containing lactam is found to be superior by about 1.6 logs.

The applicability of the method of microbicidal treatment of a surface in a confined space may be limited because the evaporation of an applied thin layer will slow and may essentially stop because of the increase in RH as water evaporates from the layer. An example is given by decontamination or disinfection of a confined space for which the microbicidal composition is applied to the entire or the majority of the interior surface.

In contained spaces such as a typical office, tactical shelter, or vehicle interior, thin layers with thickness greater than about 15 to 50 μm will lead to significant rise in RH. This can be calculated by consideration of the volume of the space V₀ and its treated (wetted) surface area S₀. Note that for water at 25° C., p_{ws}=17.34 Torr, i.e., p_{ws}=0.0228 atm, which corresponds to 22.8 l/m³. This is approximately 0.95 moles, as 1 mole=22.4(T/273) liters (where T is the temperature in ° K), or approximately 17 g/m³ of water vapor. In this case, RH=50% corresponds with approximately 8½g/m³ of water. The equivalent film thickness Δₑ on area S₀ is

$${Δ}_{e} = \frac{{p}_{ws} {V}_{0}}{RT} \frac{{M}_{w}}{{S}_{0} {ρ}_{w}} ( 1 - \frac{RH}{100} ) , \qquad ( 22 )$$

where R=8.31 moles/K and p_{ws} is in Pa, M_{w}=0.018 kg, and ρ_{w}=1×10³. For water at T=293 K (25° C.), p_{ws}=2.3×10³ Pa.

As an example, consider a space with dimensions of 3×3×4 m and the thin film is applied to the entire interior surface. In this case, S₀=66 m², and V₀=36 m³, then Δₑ=3.12×10⁻⁵ (1−RH/100) m. When RH is 50% initially, then a layer with Δₑ=15.6 μm evaporating entirely will lead to RH=100%, when liquid absorption into porous materials and other “losses” are negligible.

The volumetric rate of evaporation slows as RH increases, and it is described by the following equation,

$$\frac{d {\tilde{V}}_{1}}{d t} = - \frac{{\tilde{A}}_{0}}{{τ}_{e 1}} ( 1 - \frac{RH}{100} ) , \qquad ( 23 )$$

where \tilde{V}₁ is a volume of the thin film, Ã₀ is the area on a surface that corresponds to the volume, and τₑ₁≈τₑ₀ by Eqn. 16, but with RH=0.

The rate of mass evaporation, \dot{m}, is obtained by multiplying Eqn. 23 by the density, ρ, which gives.

$$\begin{matrix}\dot{m} = - ρ \frac{Area}{{τ}_{e 0}} ( 1 - \frac{RH}{100} ) \\ = - {ρ}_{w} \frac{3}{2} \frac{{D}_{w}}{{δ}_{cw}} \frac{{p}_{ws}}{{T}_{0}} \frac{{M}_{w}}{{ρ}_{w} R} {S}_{0} ( 1 - \frac{RH}{100} ) \\ = \frac{{V}_{0}}{Rt} \frac{d p}{d t} {M}_{w}\end{matrix} \qquad ( 24 )$$

Consequently, the rate of change in the partial pressure of water is given by,

$$\frac{d p}{d t} = - \dot{m} \frac{RT}{{M}_{w} {V}_{0}} \\ and \\ \frac{1}{{p}_{ws}} \frac{d p}{d t} = \frac{3}{2} \frac{{D}_{w}}{{δ}_{cw}} \frac{{S}_{0}}{{v}_{0}} ( 1 - \frac{RH}{100} ) . \qquad ( 25 )$$

Define the humidity complement parameter, Ψ=1−RH/100, then,

$$\frac{d Ψ}{d t} = - \frac{3}{2} \frac{{D}_{w}}{{δ}_{cw}} \frac{{S}_{0}}{{V}_{0}} Ψ . \qquad ( 26 )$$

The solution to Eqn (26) is

$$χ = \frac{1 - \frac{RH ( t )}{100}}{1 - \frac{RH ( t = 0 )}{100}} = exp \{ - \frac{3}{2} \frac{{D}_{w}}{{δ}_{cw}} \frac{{S}_{0}}{{V}_{0}} t \} = exp \{ - α t \} , \qquad ( 27 )$$

And the characteristic exponentiation time for the decrease in Ψ=1−RH/100 is given by,

$${a}^{- 1} = \frac{2 {δ}_{cw} {V}_{0}}{3 {D}_{w} {S}_{0}} . \qquad ( 28 )$$

As an example, consider the space with dimensions of 3×4×3 m. if δ_{cw}=0.02163, X=1.2 m, ν⁰=0.2 m/s, and D_{w}=2.6×10⁻⁵ m²/s, S₀=66 m², V₀=36 m³, then a=1.35×10⁻³, and a⁻¹=741 s=12.35 min. If X=0.5 in, then the time for to decrease by half is t_{1/2}=0.693 a⁻¹=514 s (=8.56 min). Thus, for use of the method of microbicidal treatment of a surface with an evaporating film, the benefits of the instant invention are best obtained when tₑ<a⁻¹.

Calculations, observations, and extensive experience with microbicidal efficacy testing guide the selection of the key parameters and conditions for obtaining the benefits of the method for microbicidal treatment of a surface of the instant invention. In preferred embodiments of the method, the application of the microbicidal composition forms a layer a thickness such that the desired T_{c}, is greater than about 20% of the evaporation time tₑ, i.e., T_{c}/tₑ>0.2, and in a more preferred embodiment, T_{c}/tₑ>0.5. For indoor use in typically ventilated rooms, when RH is in the range of about 30% to about 60%, an initial layer thickness in the range of about 10 μm to about 40 will have tₑ, in the range of about 1.3 to about 7.5 minutes. In this case, in a preferred embodiment for sanitizing treatment with T_{c}˜30 sec, a layer with initial thickness of 10 μm to 25 μm will result in an enhancement factor for the log reduction in the range of about 1.25 to about 1.5. Also for this indoor case, in a preferred embodiment for disinfecting treatment with T_{c} of about 2 minutes, a layer with an initial thickness of about 25 μm to about 40 μm will have tₑ in the range of about 2.5 to about 7.5 min, and so result in an enhancement factor for the log reduction in the range of about 1.2 to about 4. In a preferred embodiment for sporicidal disinfection treatment with T_{c} of about 5 minutes, a layer with an initial thickness of about 50 μm will have tₑ in the range of about 5.5 to about 9.5 min, and so result in an enhancement factor for the log reduction in the range of about 1.7 to about 4.

For aerosol spray application, the amount of microbicidal composition applied to the surface to form a layer of a desired initial thickness can be selected by adjusting the spray applicator spray parameters such as flow rate, droplet size, and distance between the sprayer nozzle and the surface to be treated, and, for hand pumped sprayers, additionally selecting the number of pump actuations. In a preferred embodiment, the sprayer is a hand held, hand pumped aerosol sprayer that delivers about 25 μl to about 100 μl per pump actuation.

For pre-wetted wipe applications, especially wipes packaged as pre-wetted wipes, the amount of microbicidal composition applied to the surface can be selected by the choice of the saturation ratio, i.e., the ratio of the mass of the microbicidal composition to the mass of the wipe, the size of the wipe, the efficiency of transfer, which is the ratio of the mass of microbicide transferred to the surface and the mass of microbicide initially in the wipe, and the area to be treated. Further, as known in the art, the transfer efficiency further may depend on the wipe material and its physical and chemical properties, morphology, which may depend on manufacturing method as well as its construction, and on its absorptive properties. In a preferred embodiment, the saturation ratio is in the range of about 0.5 to about 10. In a more preferred embodiment, the saturation ratio is in the range of about 1 to about 3, and the efficiency of transfer is in the range of 40% to about 75%. Another important use parameter is the ratio of treated area to wipe area. In a preferred embodiment, the ratio of treated area to wipe area is in the range of about 1 to about 4. The smaller value corresponds to thicker initial film thickness as is desirable for sporicidal disinfection treatment and longer T_{c}, and the larger value corresponds to a thinner initial film thickness as is desirable for sanitizing treatment and shorter T_{c}.

The formulation of the microbicidal composition is important to the success of the method of treatment. In a preferred embodiment, the microbicidal composition comprises hydrogen peroxide in concentration in the range of about 0.4 to 8% by weight, peracetic acid in concentration in the range of about 0.02 to about 0.55% by weight, acetic acid in concentration less that about 8% by weight, phosphate ester surfactant in concentration in the range of about 0.01 to about 0.5% by weight, water soluble polymer containing lactam in concentration in the range of about 0.01 to about 0.5% by weight, less than 0.2% by weight of stabilizers in the group consisting of inorganic phosphates, phosphonates, organic phosphonic acids or their salts, ethylenediaminetetracetic acid or its sodium salt, less than about 1 ppm of mono- and divalent metal ions, less than about 1 ppm of halide ions, less than 0.5% by weight of minors selected from the group of fragrance, colorant, and aesthetic enhancements, and a balance of water.

In a more preferred embodiment, the microbicidal composition comprises hydrogen peroxide in concentration in the range of about 3.5 to 5% by weight, peracetic acid in concentration in the range of about 0.15 to about 0.35% by weight, acetic acid in concentration less that about 5.5% by weight, phosphate ester surfactant in concentration in the range of about 0.05 to about 0.3% by weight, water soluble polymer containing lactam in concentration in the range of about 0.05 to about 0.3% by weight, less than 0.2% by weight of stabilizers in the group consisting of inorganic phosphates, phosphonates, organic phosphonic acids or their salts, ethylenediaminetetracetic acid or its sodium salt, less than about 1 ppm of mono- and divalent metal ions, less than about 1 ppm of halide ions, less than 0.5% by weight of minors selected from the group of fragrance, colorant, and aesthetic enhancements, and a balance of water.

Another important parameter is the choice of surfactant and polymer. In a preferred embodiment, the polymer is a homopolymer or copolymer of polyvinyl pyrrolidone and exemplary surfactants are anionic phosphate surfactants not limited to OC-40 manufactured by Hercules, Inc. of Wilmington, Del. This family of surfactants is characterized by the R terminal lipophilic alkyl hydrocarbon chain in range of C9 thru C13, a hydrophilic PEO polyoxyethylene chain in a range of PEO-3 to PEO-9 and a Z terminal mono and diester phosphate. The lactam-containing polymer and anionic surfactant are essential to obtain the desired characteristics of the composition, although they are present in small percentage by weight. These ingredients are selected so that the combination of anionic surfactant and lactam-containing polymer aid in providing microbicidal efficacy, especially for CT_{c} enhancement in an evaporating thin film of the composition. The anionic surfactant and polymer are further selected for their rheological properties so that the composition will form a good film when sprayed or applied by wiping, and yet, the polymer and surfactant do not greatly increase the viscosity or surface tension of the composition so as to preclude good transfer efficiency when applied as an aerosol spray. Further, the surfactant itself has some microbicidal efficacy and also has very good properties as an anti-corrosive, which is very important so that the composition has good material compatibility characteristics, i.e., does not adversely affect the material of the surface to which it is applied. The polymer-surfactant interaction provides for effective dispersion in the pH range and has sequestrant properties that contribute to the equilibrium stability of hydrogen peroxide and peracetic acid. The unique aqueous soluble polymer-surfactant interaction provides a film forming capability to the formulation and further provides an anti-corrosive effective on metal surfaces. Another advantage of the polymer and surfactant combination is the essentially thorough sequestration of metals and metal ions so that the reactions of the Metals and metal ions with the active ingredients are effectively eliminated so that, except for minor and acceptably small rates of degradation of the hydrogen peroxide, peracetic acid, and/or acetic acid, the metals and metal ions do not play a significant role in the chemistry, use, or efficacy of the composition. Further, the combination promotes stabilization of dielectric properties of the formulations when utilized in electrostatic spray applications. When the surfactant and polymer are each present in the microbicidal composition in concentration less than about 0.5% w/w, acceptably little residue for most uses remains after evaporation of the composition. In a preferred embodiment, the polymer has a molecular weight in the range of about 4000 to about 20,000, and is present in a by-weight concentration in the range of 0.05% to about 0.5%. In a more preferred embodiment, the surfactant is present in the range of about 0.05% to about 0.5%. In a preferred embodiment with lower residue, the concentration of polymer and surfactant are each less than 0.3% w/w.

With the preferred surfactant and polymer, the composition has a low corrosion rate on most materials. The principal anti-corrosive in the composition is the anionic surfactant. In a preferred RTU embodiment with about 4.4% w/w hydrogen peroxide, about 0.23% w/w peracetic acid, about 4.9% w/w acetic acid, about 0.1% PVP polymer, and about 0.1% w/w tridecyl alcohol ethoxylate phosphate ester anionic surfactant, and less than about 0.1% w/w stabilizer and sulfuric acid, and optionally less than about 0.4% w/w fragrance, it is found that a typical initial immersion corrosion rate on reactive metals, copper for example, is about 4 mils/cm²-yr. This corresponds to a material loss of about 4 μg/cm² per hour of immersion. Such a corrosion rate is sufficiently low so that this RTU microbicidal composition is not classed as a corrosive and subject to the Department of Transportation shipping constraints as a Class 8 UN/DOT material. However, for spray or wipe applications, the immersion test results are not easily extrapolated to the use as an evaporating microbicide. So, tests have been performed in which various test articles and materials were repeatedly sprayed with the microbicidal composition, which was allowed to air dry between sprayings. The composition was applied at a rate of about 50-100 ml/m², and the spraying and drying cycle was repeated 20 times. Other than light surface tarnish on reactive metals, notably the transition metals, copper, nickel, magnesium, and zinc, there was no significant corrosion or mass loss. For materials other than some of the reactive metals, there was no observable adverse aesthetic change. For absorptive materials, a very slight swelling and a slight weight gain were observed. Surprisingly, even though the concentration of the solutes in the composition increases dramatically during the evaporation, no significant deleterious material effects occur.

The method of microbicidal treatment by an evaporating thin film is well suited for the additional step of illumination with light for producing photochemical species and also obtaining direct photo-killing and inactivation of microbes. This additional step is enabled in a preferred embodiment when the microbicidal composition is also a photosensitizer. In a photosensitizer, it is important that the anionic surfactant not merely be photoabsorptive, but that it is photoreactive and beneficially promote the formation of microbicidal species, for example, ions and radicals. In a preferred embodiment, the anionic surfactant is photoreactive and is a phosphate ester. In a more preferred embodiment, the surfactant is an alkyl ethoxylate phosphate ester. With the compositions described above for preferred embodiments, a light fluence greater than or equal to about 45 ml/cm² of light in the visible and ultraviolet parts of the spectrum provides for sporicidal and disinfecting efficacy. In a still more preferred embodiment, the light used for such photosensitized killing and photo-killing is in the spectral range of about 210 nm to about 400 nm. In this case, the destruction of Deoxyribonucleic acid (DNA) and/or Ribonuclei acid (RNA) and other nucleic acid compounds results when the fluence is greater than or equal to about 30 ml/cm². In a still more preferred embodiment, the light is greater than or equal to about 30 mJ/cm² in the spectral region of 210 nm to about 315 nm.

### Process for Accurately Making a Very Dilute, Storage Stable Microbicidal Composition

In a preferred embodiment of the method of microbicidal treatment of a surface with an evaporating microbicidal thin film of the instant invention, the microbicidal composition is a storage stable, very dilute peracetic acid solution. However, to make such a composition with sufficient storage stability so that the concentrations of the principal active ingredients, namely the concentration of hydrogen peroxide, [HP] (where the square brackets [ ] denote molar concentrations), and the concentration of peracetic acid, [PAA], remain for one year or longer within relatively narrow ranges about the nominal values for each chemical to meet requirements for regulatory approval, it is necessary that the microbicidal composition resulting from the production process have [HP] and [PAA] very close to selected target concentrations that may differ from the nominal values.

The target concentrations are selected so that the composition will remain in compliance within regulatory limits, in spite of anticipated changes in [PAA] and [HP]. An example of such limits are the Upper Certified Limit and Lower Certified Limit that are specified for a product that is registered with the U.S. Environmental Protection Agency (US EPA) under the Federal Insecticide, Fungicide, and Rodenticide Act.

Because, in a preferred embodiment [HP]/[PAA] is in a range of about 10 to about 30, and [PAA]<<[AcOH], the peracetic acid can be susceptible to a substantial secular temporal change that leads to [PAA] being outside the regulatory permitted limits. The change in [PAA] can result from equilibrium shift because of degradation and decomposition reactions, or other loss of hydrogen peroxide, acetic acid, or peracetic acid. It also can result from loss of water or other ingredients by evaporation or permeation into or through a container. Further, the change in equilibrium concentrations also may be the result of errors in manufacturing the target composition.

Another contribution to change in [PAA] is reaction of the constituents of the composition with a container, or in the case of pre-wetted wipes, by reactions between the constituents of the composition and the wipe material or impurities associated with the wipe material.

One approach to reduce degradation of hydrogen peroxide, peracetic acid, and acetic acid is to use ingredients that have low impurity content. In particular, the use of water that has low content of mono- and di-valent metals, halides, and organics is essential as water is the majority ingredient of the very dilute solution. In a preferred embodiment, the water is de-ionized and reverse osmosis filtered (DI/RO) water with mono- and di-valent metals in concentration below one part per million (ppm), and with species such as iron, copper, manganese, zinc ions and the like each preferably in concentration less than 100 parts per billion (ppb). However, it is also important that the other ingredients, namely the peracetic acid stock solution, the glacial acetic acid, the hydrogen peroxide stock solution, the polymer containing lactam, the phosphate ester surfactant, and minor ingredients all have low concentrations, in a preferred embodiment less than about 10 ppm, and in a more preferred embodiment less than about 1 ppm, of impurities such as organics, halides, and mono- and di-valent metal ions. The use of such low impurity materials can contribute greatly toward minimizing the degradation of the major constituents of the composition, but this approach is not sufficient to ensure storage stability of very dilute peracetic acid solutions.

Another approach to obtain storage stability is to use stabilizers. So-called storage stable stock hydrogen peroxide solutions are available commercially with hydrogen peroxide concentration in the range of 30 to 70% w/w and also containing up to about 500 ppm of stabilizers such as colloidal stannate compounds, stannic phosphate, thymol, sodium orthophosphate, organophosphonates, hydroquinone, and acetanilide. When the stock hydrogen peroxide solution is added to make the microbicidal composition, the stabilizer is diluted by about an order of magnitude, so in the resulting composition, stabilizer is present in relatively small amounts. Similarly for the peracetic acid stock solution, stabilizer is often present, and an acid catalyst is also typically present, for example, sulfuric acid in an amount up to about 1% w/w. For a peracetic acid stock solution comprising about 15% w/w peracetic acid, about 22% w/w hydrogen peroxide, and about 16% w/w acetic acid, stabilizer, acid, and a balance of water, addition to a batch to make the microbicidal composition will result in the stabilizer and sulfuric acid being diluted by more than an order of magnitude to less than about 0.1% w/w of the resulting composition. Although the residual amount of stabilizer can significantly contribute to stabilization of the composition and can effectively sequester metals and their ions that would pose a threat to storage stability, stabilizer alone in such small concentration has not been sufficient to achieve storage stability of a very dilute peracetic acid solution.

Yet another approach is to blend the composition at equilibrium or near-equilibrium. This approach in combination with the use of low impurity materials and stabilizer can help greatly in slowing the rate of a secular temporal variation in the concentration of the principal active ingredients. The prior art provides a variety of prescriptions for determining equilibrium conditions, which include experimental modeling and parametric variation to select equilibrium concentrations, or use of excess acid content by comparison with the hydrogen peroxide or other formulations that exhibit apparent stability. However, such seemingly successful examples do not inform the formulation of a very dilute peracetic acid solution that contains phosphate ester surfactant and polymer containing lactam.

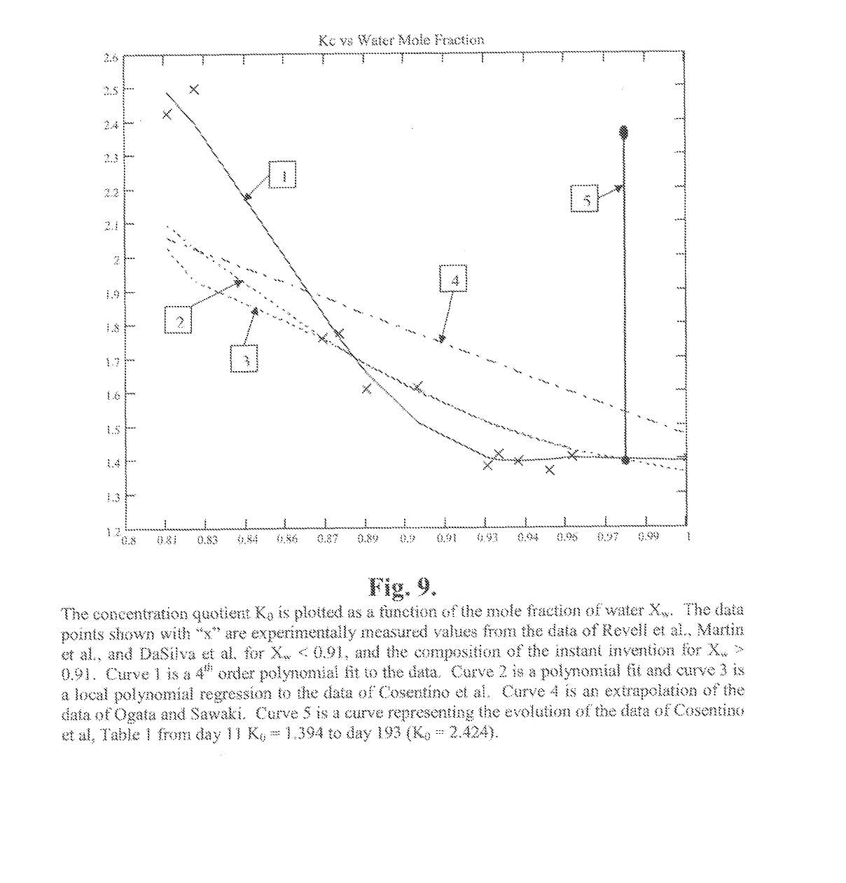

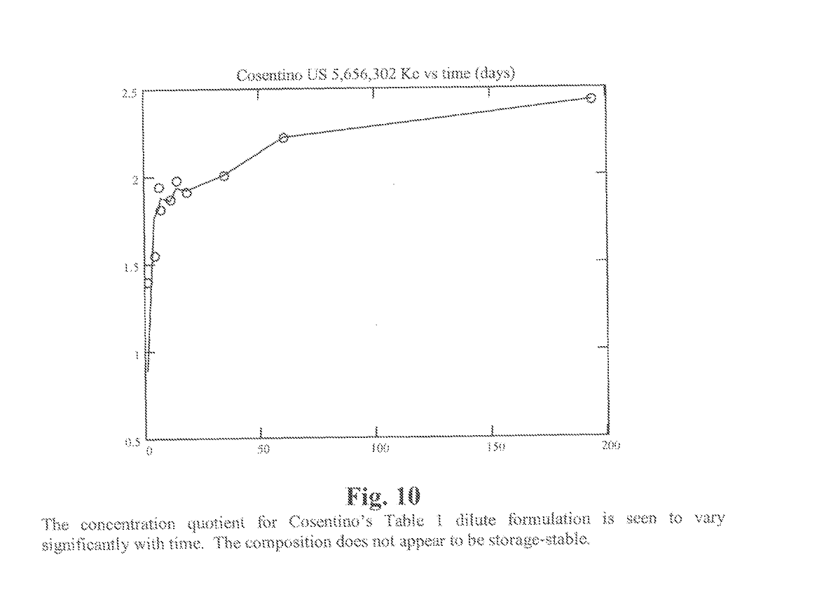

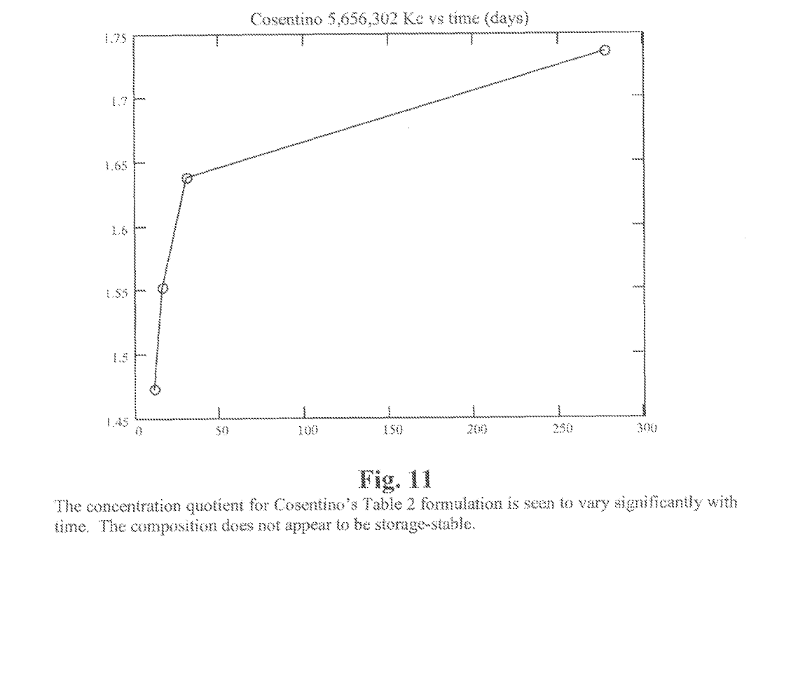

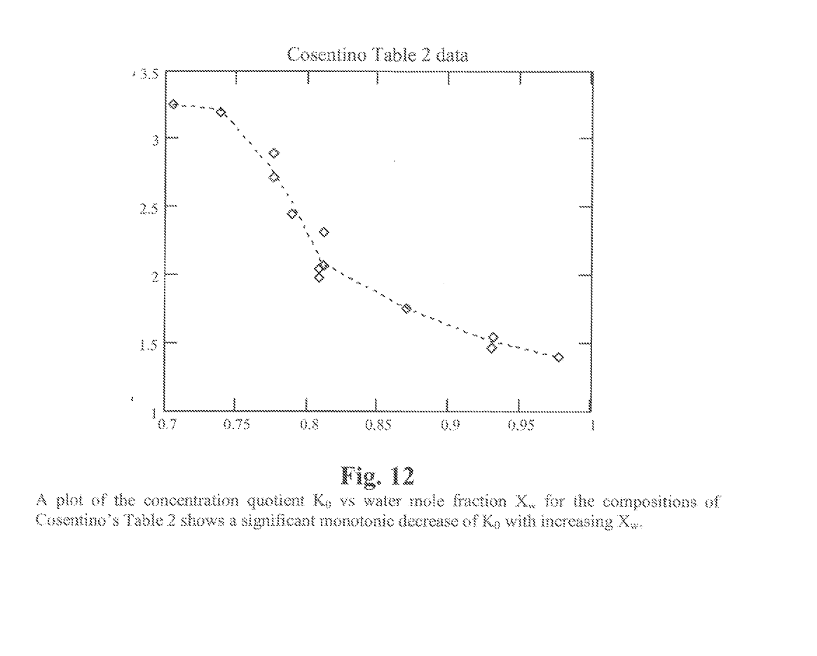

The prior art does not provide adequate information about the value of K_{c} (see Eqn. 3, above), notwithstanding the recent results of Zhao et al and the much earlier results of Sawaki et al. This is seen in FIG. 9, which shows the value of K_{c} as a function of water mole fraction, X_{w}, for microbicidal compositions with hydrogen peroxide and peracetic acid as the principal active ingredients. The values of K_{c} are either reported values or based on manufacturer statements about the formulation of their composition. The data points shown with “x” are experimentally measured values from the data of U.S. Pat. No. 5,489,706 to Revell et al., Martin et al., and DaSilva et al. for X<0.91, and for the composition of the instant invention for X_{w}>0.91. Curve 1 is a 4^{th} order polynomial fit to the data. Curve 2 is a polynomial fit and curve 3 is a local polynomial regression to the data of Cosentino et al. Curve 4 is an extrapolation of the data of Sawaki et al. Curve 5 is a curve representing the evolution of the data of Cosentino et al, Table 1 from day 11 (K=1.394) to day 193 (K, =2.424). It is apparent that the plateau seen for X_{w}>0.91, which includes the compositions of the instant invention is not anticipated by the prior art. In particular, as shown in FIG. 10, where is plotted against time, the dilute composition of Cosentino et al, Table 1, is seen to vary significantly with time. The composition does not appear to be storage-stable. Further, as shown in FIG. 11, where K, is plotted against time, the dilute composition of Cosentino et al, Table 2, is seen to vary significantly with time. The composition does not appear to be storage-stable. By plotting the data for the exemplary compositions of Cosentino et al, Table 2, as K_{c} as a function of X_{w}, as shown in FIG. 12, it is seen that the curve does not have a plateau for X_{w}>0.91, in contrast to the results for the composition of the instant invention. Another composition with X_{w}˜0.93 is that of U.S. Pat. No. 5,851,483 to Nicole for which a very dilute solution has K_{c}˜1.9. This composition is claimed to be storage stable for more than a year, but its value of K_{c} differs that of the compositions of the instant invention, likely because of the stabilizers in the composition of Nicole and the lack of phosphate ester surfactant and polymer.

In practice and in the non-ideal situation for which the reactions (see paragraph [0038]) are not independent of the other reactions and loss or degradation processes that may change the concentrations of the reactants, the relationship (see paragraph [0040]) for K_{c} is not accurately achieved. It is found that theoretical predictions and empirical values for K_{c} determined for solutions with peracetic acid concentration greater than about one percent differ significantly from the value determined for the compositions of the instant invention. Further, it is found that K_{c} depends on the type and amount of stabilizer present in the solution [see, for example, U.S. Pat. No. 5,767,308 to Thiele et al, wherein various stabilizers are shown to result in different equilibration times, and so different reactions rates are inferred].

For compositions with X_{w}<0.91, is found in the range of about 1.6 to about 3.5 for solutions at about room temperature. Analysis of several commercial peracetic acid/hydrogen peroxide compositions reveals that the majority of compositions comprises equilibrium or near equilibrium solutions with K_{c} in the range of 2.9 to 3.5. Zhao et al also reports K_{c}˜2.9. In contrast, however, Dul'neva et al. report K_{c} in the range of 2 to 2.2 and activation energies that are lower than those reported by Zhao.

Sawaki et al studied the variation of K_{c} with Hammett's acidity function for concentrated solutions of peracetic acid, hydrogen peroxide, and acetic acid. They showed that K_{c} increases slowly as a function of Hammett's acidity function. In particular, at very high concentration of peracetic acid, they hypothesized that because the concentration of water is low and the demand for water for hydration of the other species is high, that available ‘free’ water is reduced. The result is an increased value in K_{c}. For lower concentration solutions, Sawaki et al pointed out that ion clustering and the formation of complexes make K_{c} no longer clearly dependent on the acidity function, and so useful extrapolation of their curve to very dilute solutions is precluded.

Knowing the value of K_{c} for very dilute peracetic acid solutions enables calculation of the equilibrium concentrations, p=[FAA], h=[HP], v=[AcOH], and w=[H₂O], for lossless equilibration by the reactions (see paragraph [0038]) for an initial mixture with starting constituent molar concentrations, p₀=[PAA]₀, h₀=[HP]₀, v₀=[AcOH]₀, and w₀=[H₂O]₀, where the subscript, “0”, denotes the quantity as a starting value. Further the weight/weight percentage (5 w/w) concentrations of peracetic acid, hydrogen peroxide, acetic acid, and water are related to the molar concentrations by P₀=p₀Mₚ/10ρ, h₀Mₕ/10ρ, V₀=v₀Mᵥ/10ρ, W₀=w₀M_{w}/10ρ, where Mₛ is the molecular weight of constituent “s” in g/mole, and ρ is the density of the solution in g/ml. When the solution contains a w/w percentage of inert ingredients, I, the water concentration is related to the other constituents by

W=100−I−(P+H+V). (29)

For a lossless system, the equilibration reactions (see paragraph [0038]) can be stated as a set of differential equations,

$$\begin{matrix}\frac{d p}{d t} = {k}_{1} h v - {k}_{2} pw , & ( 30 a ) \\ \frac{d h}{d t} = - {k}_{1} h v + {k}_{2} pw , & ( 30 b ) \\ \frac{d w}{d t} = {k}_{1} h v - {k}_{2} pw , \\ and & ( 30 c ) \\ \frac{d v}{d t} = - {k}_{1} h v + {k}_{2} pw , & ( 30 d )\end{matrix}$$

With stoichiometric balance, p=p₀−Δ, w=v₀−Δ, h=h₀+Δ, v=v₀+Δ, and Eqns. 29 and 30, with

$${K}_{c} ( T ) = \frac{{k}_{1} ( T )}{{k}_{2} ( T )}$$

can be solved to yield,

$$\begin{matrix}Δ = \frac{χ}{2 ( 1 - {K}_{c} ( T ) )} [ 1 - {\{ 1 - [ \frac{4 ( 1 - {K}_{c} ( T ) ) ( {p}_{0} {w}_{0} - {K}_{c} ( T ) {h}_{0} {v}_{0}}{{χ}^{2}} ] \}}^{1 / 2} ] \\ and & ( 31 a ) \\ χ = {w}_{0} [ 1 + \frac{{p}_{0} + {K}_{c} ( T ) ( {h}_{0} + {v}_{0} )}{{w}_{0}} ] . & ( 31 b )\end{matrix}$$

Concentrations calculated by Eqns. 31a and 31 h are typically accurate within a few percent for solutions with T near room temperature and when losses are very small. However, at elevated temperatures, the calculated predictions may significantly depart from experimentally measured concentrations. Such inaccurate prediction at elevated temperature is undesirable because it makes difficult achievement of target concentrations that maximize the duration of storage stability within regulatory limits.

Preparing and equilibrating a batch of the microbicidal composition at an elevated temperature is known in the prior art as a way to reduce the equilibration time (for example, see, U.S. Pat. No. 4,297,298 to Crommelynck et al., U.S. Pat. No. 5,565,231 to Malone et al., U.S. Pat. No. 5,767,308 to Thiele, and U.S. Pat. No. 5,886,216 to Pudas), and so, reduce the manufacturing time that may be up to about 3 equilibration/exponentiation times. The manufacturing time can be about a month for hatching at room temperature, and in contrast, it can be about two and half clays at T=55° C. Since degradation and decomposition reactions and interactions with containers begin as soon as the ingredients are combined in the manufacturing process, reducing the manufacturing time is desirable so that the resulting composition can be packaged sooner as a composition with constituent concentrations that are within the regulatory acceptable limits, and can have a longer shelf life before degradation and decomposition reactions make it unacceptable. An additional advantage of reduced manufacturing time is that the manufacturing resources have a greater throughput. In particular, batching at sufficiently elevated temperature so that at least one or, better yet, two hatches per standard work week can be prepared, equilibrated sufficiently, analyzed to meet release criteria, and packaged impacts manufacturing capacity and economic return on capital investment favorably even though hatching at elevated temperature requires a blending tank that is maintained at the elevated temperature and may also require a means for rapidly cooling the tank to further reduce the time between the start of the batch and packaging or storage.

However, according to the prior art, there may be a disadvantage to batching at elevated temperature because of the decomposition of peracetic acid into acetic acid and oxygen, i.e.,

2CH₃COOOH [symbol] 2CH₃COOH+O₂. (32)

The reaction rate, k₃, for Eqn. 32, recently reported by Zhao, et al for dilute peracetic acid solutions, can amount to a substantial fractional change in peracetic acid and acetic acid because of the larger amount of these constituents in dilute solutions. However, we have found that with the smaller concentrations of these constituents in very dilute solutions, that the decomposition of peracetic acid amounts to a few percent change in these constituents so long as the time at elevated temperature is a few clays or less. By Zhao's formula for k₃,

$${k}_{3} = {K}_{2} {k}_{4} \frac{[ {H}^{+} ]}{{( 1 + {K}_{2} [ {H}^{+} ] )}^{2}} , \qquad ( 33 )$$

where, according to Zhao et al,

$${K}_{2} = 2.528 \times {10}^{6} exp \{ \frac{- 30151.55}{RT} \} and$$

$${k}_{4} = 1.075 \times {10}^{13} exp \{ \frac{- 88377.82}{RT} \} ,$$

and where [H⁺] is the concentration of hydrogen ion, which can be estimated per Zhao et al. or determined by measurement of the pH=−log [H⁺].

Nonetheless, the decomposition of peracetic acid during elevated temperature batching of very dilute solutions cannot be ignored if the object is an accurately made composition with concentrations that are very close to target concentrations. Additionally, the evaporation of water from unsealed or open batch containers or tanks also must be taken into account. Such evaporation can be estimated by the use of Eqns. 24 and 9. For a covered but ventilated upright cylindrical tank with about 3 m diameter, stirred at a few rpm to obtain thermal mixing, a typical water evaporation rate, ψ, of a very dilute solution is on the order of about ψ˜0.5−1×10⁻⁴ per hour. So, in 60 hours of hatching, the evaporated water loss amounts to about one half percent.

Further, degradation of peracetic acid, hydrogen peroxide, and acetic acid also can be taken into account. Commonly, blending tanks are made of Austenitic stainless steel. In a preferred embodiment, the alloy is type 316 stainless steel. It is also common practice to passivate the tank, e.g., by rinsing the interior tank wall with nitric or citric acid and then rinsing the tank with DI/RO water, and then, still further, rinsing it with a dilute hydrogen peroxide solution, for example, a 4% solution. Experiments with elevated temperature hatching very dilute peracetic acid solutions in well passivated Austenitic stainless steel tanks were performed, and we discovered that there are additional advantages of adding the polymer containing lactam and then the phosphate ester surfactant to hot DI/RO water in the tank prior to adding the other constituents of the composition. One advantage is that the degradation of hydrogen peroxide by interaction with the tank wall material is less by a factor of a few, e.g., about 3 to about 5, and amounts, typically, to about 1×10⁻⁵ percent per hour per m² of tank wall surface area. Other advantages are that the polymer and surfactant are more easily dissolved and can, in the presence of metals and metal ions, especially mono- and di-valent species, in concentration less than about 1 ppm, in essence, thoroughly sequester metals and metal ions prior to the addition of the other ingredients so that the reactions of the metals and metal ions with the active ingredients are effectively eliminated and so that, except for minor and acceptably small rates of degradation of the hydrogen peroxide, peracetic acid, and/or acetic acid, the metals and metal ions do not play a significant role in the chemistry, use, or efficacy of the composition. For a production size tank of about 25 m³ capacity, and when the polymer and surfactant are added prior to the other ingredients, the degradation rate for hydrogen peroxide is about δₕ˜3×10⁻⁴ percent per hour. It is found that the degradation rates for peracetic acid, δₚ, and acetic acid, δᵥ are comparable or less by a factor of a few, i.e., δp, δᵥ˜1×10⁻⁴ percent per hour.

Batches may also be prepared in plastic tanks that can be heated. In a preferred embodiment, a plastic blending tank is made of high density polyethylene (HDPE), or polypropylene, or a combination of stainless steel, plastic, and/or compatible metals that are known in the art. Also, the piping, pump components, mixing blade, and other components that may contact the microbicidal composition must be made of compatible materials. Generally passivation of a plastic tank is not necessary, but the tank must be well cleaned, for example by thoroughly washing and then rinsing the tank with DI/RO water or other low impurity water. However, interaction with the tank may still occur at elevated temperature. This may occur because of interaction between the constituents of the composition and the material of the tank and/or with contaminants not removed by prior tank cleaning. For an HDPE plastic tank, cracking and crazing may eventually occur that reduce the lifetime of the tank. Further, a heated plastic tank may not be as durable as a metal tank. However, for smaller batches, for example batches of less than about 2 m³, the cost of a plastic tank may be much less than a comparable stainless steel tank. Small batches have conveniently been made in well cleaned HDPE plastic drums that are heated with thermostatically controlled electric blankets.

Knowing the evaporation rate, and decomposition and degradation rates, allows a prediction of concentrations during the equilibration process can be determined. For a system with loss reactions involving peracetic acid, hydrogen peroxide, and acetic acid that include degradation, decomposition, interactions with the container or tank, and evaporation of water, the equilibration reactions can be stated as a set of differential equations,

$$\begin{matrix}\frac{d p}{d t} = {k}_{1} hv - {k}_{2} pw - ( {δ}_{p} - ψ ) p - {k}_{3} {p}^{2} , & ( 34 a ) \\ \frac{d h}{d t} = - {k}_{1} hv - {k}_{2} pw - ( {δ}_{h} - ψ ) h , & ( 34 b ) \\ \frac{d w}{d t} = {k}_{1} hv - {k}_{2} pw - ψ w + {δ}_{p} p + {δ}_{h} h + {δ}_{v} v , \\ and & ( 34 c ) \\ \frac{d v}{d t} = - {k}_{1} hv + {k}_{2} pw - ( {δ}_{v} - ψ ) v + {k}_{3} {p}^{2} , & ( 34 d )\end{matrix}$$

These equations can be integrated as an initial value problem by any of several standard methods to determine the temporal variation of the concentrations in the solution. Further, by being able to predict the secular temporal variation of the solution, a process for accurately hatching the microbicidal composition is enabled. Still further, the predictive capability enables selection of post hatching target concentrations and package performance criteria.

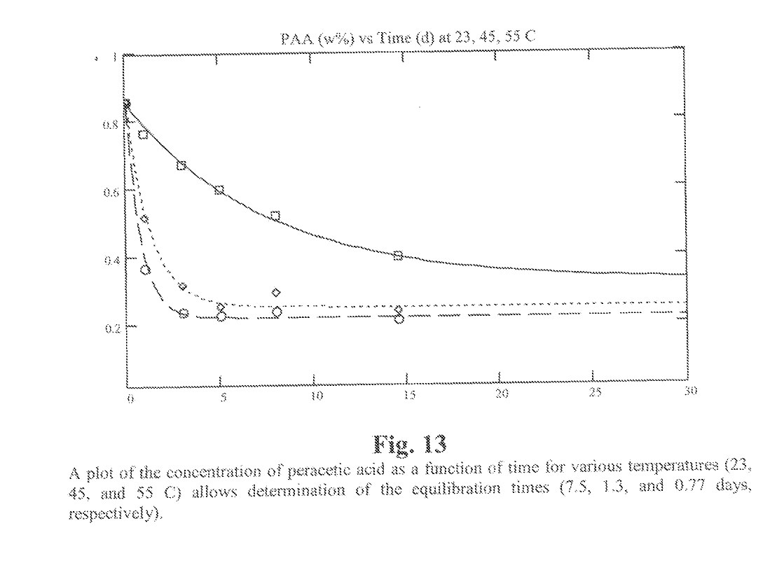

We have performed experiments with various starting concentrations, and measured the time evolution of the concentrations to determine the forward and reverse reaction rates and associated activation energies. FIG. 13 shows a plot of the concentration of peracetic acid as a function of time for various batching temperatures ((boxes) 23°, (diamonds) 45°, and (circles) 55° C.). Measurement of the decay rates allows determination of the equilibration times (7.5, 1.3, and 0.77 days, respectively).

In the preferred embodiments of the composition of the present invention it is found that is given by,

$${K}_{c} \approx 1.4 exp [ \frac{{H}_{0}}{R} ( \frac{1}{T} - \frac{1}{293.2} ) ] = \frac{{k}_{1}}{{k}_{2}} = \frac{[ PAA ] [ {H}_{2} O ]}{[ HP ] [ AcOH ]} = \frac{pw}{hv} \qquad ( 35 a )$$

at a temperature T given in degrees Kelvin and T is between about 283 and about 328 degrees Kelvin, H₀ is approximately 2000 kJ/mole, R=8.31 kJ/mole° K is the universal gas constant, and X_{w}, is greater than about 0.9. As predicted by Eqn. 35, and as found experimentally, K_{c}, increases about 10% as T decreases from 55° C. and room temperature. Furthermore, by knowing K_{c}, the equilibrium molar concentration of acetic acid can be related to the concentrations of hydrogen peroxide and peracetic acid by Eqns. 29 and 35a to obtain,

$$v = {[ 1 + \frac{p}{h {K}_{c}} \frac{{M}_{v}}{{M}_{w}} ]}^{- 1} [ \frac{p}{h {K}_{c}} ] \{ [ \frac{( 100 - 1 ) 10 p}{{M}_{w}} ] - [ \frac{{M}_{h} h}{{M}_{w}} ] - [ \frac{{M}_{p} p}{{M}_{w}} ] \} . \qquad ( 35 b )$$

The activation energies and coefficients fork, and k₂ for the compositions of a preferred embodiment, namely those comprising a very dilute peracetic acid solution containing PVP polymer and phosphate ester surfactant, are determined from the experimental data. The resulting expressions for the rates are,

$$\begin{matrix}{k}_{1} = 4.45 \times {10}^{8} [ H ] exp \{ \frac{- 58445}{RT} \} & ( 36 a ) \\ {k}_{2} = 7.1 \times {10}^{8} [ H ] exp \{ \frac{- 60445}{RT} \} . & ( 36 b )\end{matrix}$$

These rates differ from those reported by Zhao in both coefficients and activation energies.

The evolution of the hatching process can be predicted for the batch preparation of the composition at a temperature T, by knowing good estimates of the reaction rates, degradation and decomposition rates, and the evaporation and/or permeation rates, and using the model of Eqns. 34. Using this approach, we have found that conditions for accurately achieving target concentrations in the batching process, wherein the accuracy of the resulting composition and of the value of the rates is principally limited by the accuracy of analytic assay methods used to determine the concentrations. These are typically HPLC, that is calibrated by comparison with standard solutions and/or titrametric assays such as 2-step titration methods commonly practiced in the art. In our experience, these methods have accuracy in the range of about ±2% to about ±8% w/w as practiced in the conditions of a “manufacturing facility” setting.

Further, by experiment we have determined estimates of the rates for permeation and loss of water of such solutions in HDPE containers such as may be used for packaging the compositions as products. Knowing the rates for the interactions in a packaging container, and using the model of Eqns. 33-36, we have found that the evolution of the composition in the packaging container can be predicted. Consequently, the predictions can be used to select the target concentrations for the batch preparation of the composition.

We have found that in a preferred embodiment of the batch process that the starting or initial concentration of peracetic acid be greater than the target concentration by at least 15% w/w, and that the initial concentrations of hydrogen peroxide and acetic acid be less than the target values. This permits adjustment of the concentrations part way through the batch process, for example by slight dilution by the addition of water, or, more preferably, by concentration adjustments by the addition of relatively small amounts of peracetic acid stock solution, and/or hydrogen peroxide stock solution, and/or glacial acetic acid, or a combination of relatively small additional amounts of one or more of these and a small dilution with DI/RO filtered water. The greater starting value of [PAA] also provides a margin for account of measurement errors. Further, the stock peracetic acid solution may be a source of sulfuric acid and stabilizer, and so it may be advantageous to use a greater starting value of [PAA] so that these minor ingredients are provided in the step of adding the initial peracetic acid to the batch. In a preferred embodiment, the starting value of [PAA] is at least 50% greater than the target value, but less than about 6 times the target value.

The process accurately makes a batch of a storage stable microbicidal composition comprising a very dilute peracetic acid solution with the resulting composition having an equilibrium concentration quotient of about

$${K}_{c} \approx 1.4 exp \{ \frac{{H}_{0}}{R} ( \frac{1}{T} - \frac{1}{293.2} ) \}$$

at a temperature T given in degrees Kelvin and T is between about 283 and about 328 degrees Kelvin and the mole fraction of water of the said resulting composition is greater than about 0.9. According to the process, in the first step,
(1) the target concentrations are selected, these being the concentrations of hydrogen peroxide, peracetic acid, polymer, and surfactant in the resulting composition at a selected batching temperature in the range of about 40° C. to about 55° C.

The following steps are:
(2) calculating the target equilibrium concentration of acetic acid in the said resulting composition;
(3) selecting an initial concentration of peracetic acid,
(4) determining by calculation that includes the decomposition of some of the peracetic acid into acetic acid and oxygen and the evaporation of some of the water during the batch process, and optionally, the degradation of some of the peracetic acid, acetic acid, and hydrogen peroxide, the amount of a diluted solution of a more concentrated solution of known composition, designated the peracetic acid stock solution, comprising peracetic acid, hydrogen peroxide, acetic acid, acid catalyst, and water, the amount of glacial acetic acid of known composition, which may contain a relatively small amount of water, the amount of an aqueous solution of hydrogen peroxide of know composition, designated the hydrogen peroxide stock solution, the amounts of surfactant, polymer, and minors, and the amount of de-ionized/reverse osmosis filtered water to be added to the batch to obtain the target concentrations;
(5) heating about 75% up to about 100% of the amount of de-ionized/reverse osmosis filtered water in a clean, passivated blending vessel to the said selected hatching temperature and continuously mixing the contents of the said vessel to limit the spatial temperature variation of the said contents to less than about 5° C.;
(6) adding the said determined amount of water soluble polymer to and mixing with the said heated water; then
(7) adding the said determined amount of surfactant to and mixing with the contents of the vessel; then
(8) adding the determined amounts of hydrogen peroxide stock solution and glacial acetic acid to and mixing with the contents of the vessel; then
(9) adding the determined amount of peracetic acid stock solution to and mixing with the contents of the vessel; then
(10) adding the remainder of the said determined amount of water to and mixing with the contents of the vessel; then
(11) maintaining the contents of the vessel at the hatching temperature with less than about 5° C. spatial or temporal variation in the temperature of the said contents for a hatching time in the range of about 2 to 4 equilibration times; then
(12) measuring the concentrations of hydrogen peroxide, peracetic acid, and optionally acetic acid;
(13) the optional step of adjusting the composition of the blended mixture to obtain the target concentrations;
(14) the optional step of adding one or more said minor ingredients to and mixing with the contents of the vessel;
(15) cooling the contents of the contents of the vessel to a desired temperature or to ambient temperature in a time that is much less than an equilibration time, and optionally adding one or more said minor ingredients to and mixing with the contents of the vessel; then
(16) the optional step of storing the resulting composition in the vessel, or transferring the said contents to another or several vessels, or transferring the said contents to product packages, or transferring the said contents as an ingredient in one or more products.

In preparing the polymer and/or the surfactant prior to the above steps of their addition to the batch, the polymer and/or the surfactant may each be mixed with a quantity of DI/RO filtered water, which may be at elevated temperature, for example, approximately the temperature of the batch process. Such pre-mixing may lead to more ready pouring or pumping or other means of introduction of the polymer and/or surfactant to the batch, for example, reducing viscosity, or more convenient and thorough mixing. However, it is important that contaminants not be introduced into the polymer or surfactant.

In another aspect, the instant invention provides the compositions made by the above process and comprising very dilute peracetic acid solutions that are storage stable RTU microbicidal compositions that can be used in the microbicidal treatment of a surface by the method of the instant invention. Further, the compositions made by the above process comprise photosensitizer for light-activated anti-microbial efficacy.

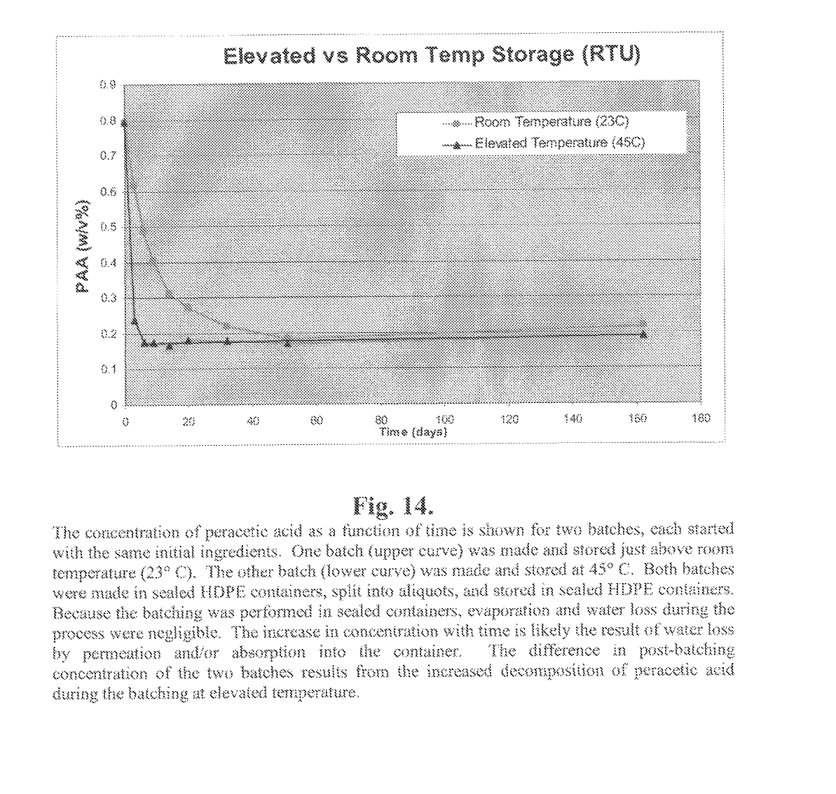

A comparison of predictive calculation and experimental measurement is shown in FIG. 14. The concentration of peracetic acid as a function of time is shown for two batches, each started with the same initial ingredients. One batch (upper curve) was made and stored just above room temperature (23° C.). The other hatch (lower curve) was made and stored at 45° C. Both hatches were made in sealed HDPE containers, split into aliquots, and stored in sealed HDPE containers. Because the hatching was performed in sealed containers, evaporation and water loss during the process were negligible. The increase in concentration with time is likely the result of water loss by permeation and/or absorption into the container. The difference in post-batching concentration of the two batches results from the increased decomposition of peracetic acid at elevated temperature and the difference in K_{c}, which is a function of temperature.

### Compositions Made by Process

The microbicidal compositions made by the hatch process of the instant invention comprise, at about room temperature, hydrogen peroxide in concentration in the range of about 2.0 to about 6% by weight, peracetic acid in concentration in the range of about 0.05 to about 0.74% by weight, acetic acid, phosphate ester surfactant in concentration in the range of about 0.025 to about 0.3% by weight, water soluble polymer containing lactam in concentration in the range of about 0.025 to about 0.3% by weight, acid catalyst in concentration in the range of 0 to about 1000 ppm by weight, less than 0.2% by weight of stabilizers in the group consisting of inorganic phosphates, phosphonates, organic phosphonic acids or their salts, ethylenediaminetetracetic acid or its sodium salt, less than about 10 ppm by weight of mono- and divalent metal ions, less than about 1 ppm by weight of halide ions, less than 0.5% by weight of minors selected from the group of fragrance, colorant, and aesthetic enhancements, and a balance of water. The combination of polymer and surfactant in the compositions of the instant invention provide, in the presence of metals and metal ions, especially mono- and di-valent species, in concentration less than about 1 ppm, essentially thorough sequestration of metals and metal ions so that the reactions of the metals and metal ions with the active ingredients are effectively eliminated and so that, except for minor and acceptably small rates of degradation of the hydrogen peroxide, peracetic acid, and/or acetic acid, the metals and metal ions do not play a significant role in the chemistry, use, or efficacy of the composition.

In a preferred embodiment, the initial starting concentration of peracetic acid is in the range of 0.75 to 1.15 w/w so that after hatching, the resulting post-batch composition has a concentration of peracetic acid in the range of 0.17 to 0.29. The starting concentrations of hydrogen peroxide and acetic acid are below the post-hatching target levels in amounts commensurate with the predictions of the results of integration of Eqns. 34. In a preferred embodiment, the surfactant is an alkyl ethoxylate phosphate ester. In a more preferred embodiment, the hatching is carried out at a temperature in the range of 50° to 55° C., and the starting concentrations of 1:09% w/w peracetic acid, 4.07% w/w hydrogen peroxide, 4.20% w/w acetic acid, 0.1% w/w PVP polymer, 0.1% w/w tridecyl alcohol ethoxylate phosphate ester surfactant, about 50-750 ppm of sulfuric acid, less than 200 ppm of stabilizers, and a balance of water having a low content of impurities, i.e., less than 1 ppm of organic compound impurities, halides, and mono- and divalent metal ions and metals. The resulting composition has target concentrations values that will equilibrate at about room temperature, namely T=20° C., to 0.23% w/w peracetic acid, 4.4% w/w hydrogen peroxide, and about 4.9% w/w acetic acid. Optionally, fragrance amounting to about 0.1 to about 0.4% w/w concentration may be added to the post-batching composition.

In a preferred embodiment, the fragrance is compatible, i.e., of low reactivity, with the constituents of the composition so that the fragrance is not functionally degraded nor is the storage stability of the resulting composition significantly reduced.

### Example 1

A composition was prepared by the above process with 3 days of batching at T=55° C. and the initial concentrations of the more preferred embodiment described above by the combination of the following ingredients:
18.21 pounds stock hydrogen peroxide solution (35% hydrogen peroxide, stabilizers, balance of water, Solvay Interox, Houston, Tex.)
18.64 pounds stock peracetic acid solution (15% peracetic acid, 22% hydrogen peroxide, 15% acetic acid, stabilizer and acid minors, balance of water, BioSide HS 15, Enviro-Tech Chemical Services, Inc., Modesto, Calif.)
8.03 pounds glacial acetic acid (99.7% acetic acid, balance water)
0.256 pounds PVP K-15 polymer (International Specialty Products, Wayne, N.J.)
0.256 pounds tridecyl alcohol ethoxylate phosphate ester surfactant (Dextrol OC-40 surfactant made by Hercules, Inc., Wilmington, Del.)
211.9 pounds DI/RO water
   Analysis of the resulting compound by HPLC and also by titrametric assay gave the following results for comparison with targeted and calculated:

TABLE II
Comparison of predicted and measured concentrations (w/w %).

| | Nominal- | Starting- | Lossless- | With losses- | 1 month- | 1 month- | 12 months- |
|---|---|---|---|---|---|---|---|
| Constituent | targeted | measured | calculated | calculated | calculated | measured | calculated |
| Peracetic acid | 0.23 | 1.09 | 0.212 | 0.2135 | 0.229 | 0.23 | 0.215 |
| Hydrogen peroxide | 4.4 | 4.07 | 4.463 | 4.492 | 4.46 | 4.40 | 4.32 |
| Acetic Acid | 4.9 | 4.20 | 4.894 | 4.972 | 4.91 | 4.90 | 4.70 |

### Example 2

A batch of microbicidal composition was prepared by the process of the instant invention with 5 days of batching at 55° C. and then storage in HDPE containers at room temperature. The target concentrations were:

TABLE III
Comparison of predicted and measured concentrations (w/w %).

| | | Post-batching Target | |
|---|---|---|---|
| | Starting | concentrations: | |
| | concentrations | Measured | Predicted |
| Peracetic acid: | 0.98% w/w | 0.21% w/w | 0.21% w/w |
| Hydrogen | 4.10% w/w | 4.50% w/w | 4.50% w/w |
| peroxide: | | | |
| Acetic acid: | 4.20% w/w | 4.80% w/w | 4.88% w/w |

| | | |
|---|---|---|
| Time | | |
| Post-batching: | Hydrogen peroxide 4.5% | Peracetic acid 0.21% |
| 3 months: | Hydrogen Peroxide 4.4% | Peracetic acid 0.22% |
| 6 months: | Hydrogen Peroxide 4.4% | Peracetic acid 0.22% |
| 9 months: | Hydrogen Peroxide 4.4% | Peracetic acid 0.22% |
| 12 months: | Hydrogen Peroxide 4.3% | Peracetic acid 0.22% |

Measurements at 3, 6, 9, and 12 months were made by titrametric assay by an independent laboratory. Also, measurements of physical properties were performed. The pH of the composition is about 2.1 and the viscosity is 1.126 mPa-s (cP) at 20° C. and 0.74 mPa-s (cP) at 40° C. By comparison, the viscosity of water is about 1.003 and 0.653 mPa-s (cP), respectively. So, the viscosity of the composition is only about 12% greater than water.

### Example 3

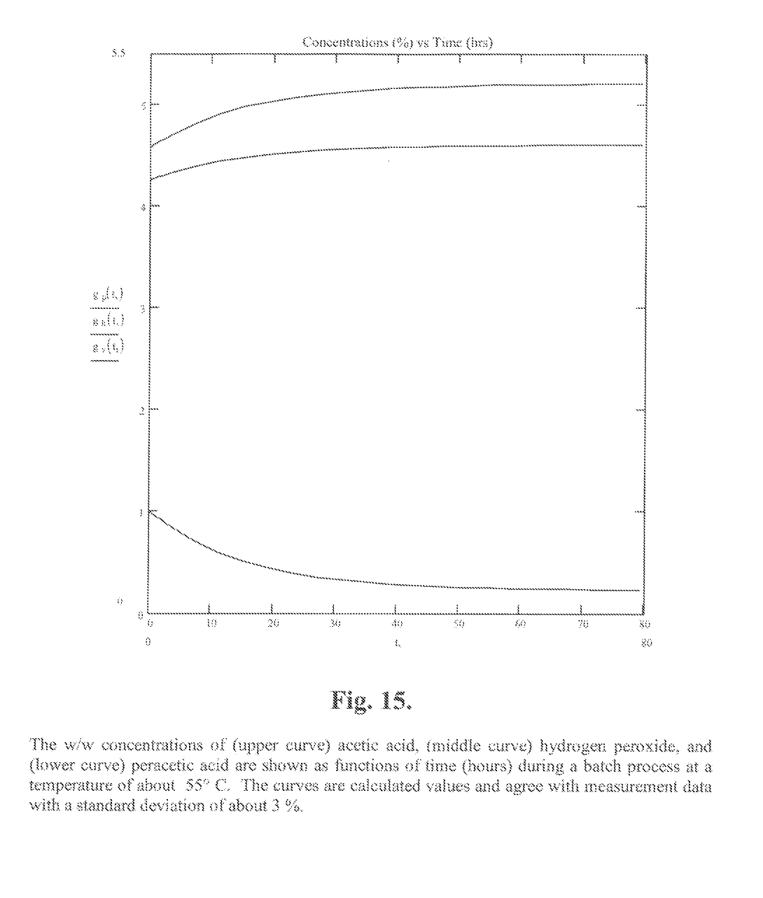

A batch was prepared with starting concentrations of 1.003% w/w peracetic acid, 4.262% w/w hydrogen peroxide, and 4.58% w/w acetic acid. The concentrations of PVP polymer and phosphate ester surfactant each were 0.1% w/w. After 60 hours of batching, the concentrations were 0.24% w/w, 4.60% w/w, and 5.19% w/w, respectively. In FIG. 15, the % w/w concentrations of (upper curve) acetic acid, (middle curve) hydrogen peroxide, and (lower curve) peracetic acid are shown as functions of time (hours) during the batch process at a temperature of about 55° C. The curves are calculated values and agree with measurement data with a standard deviation of about 3%.

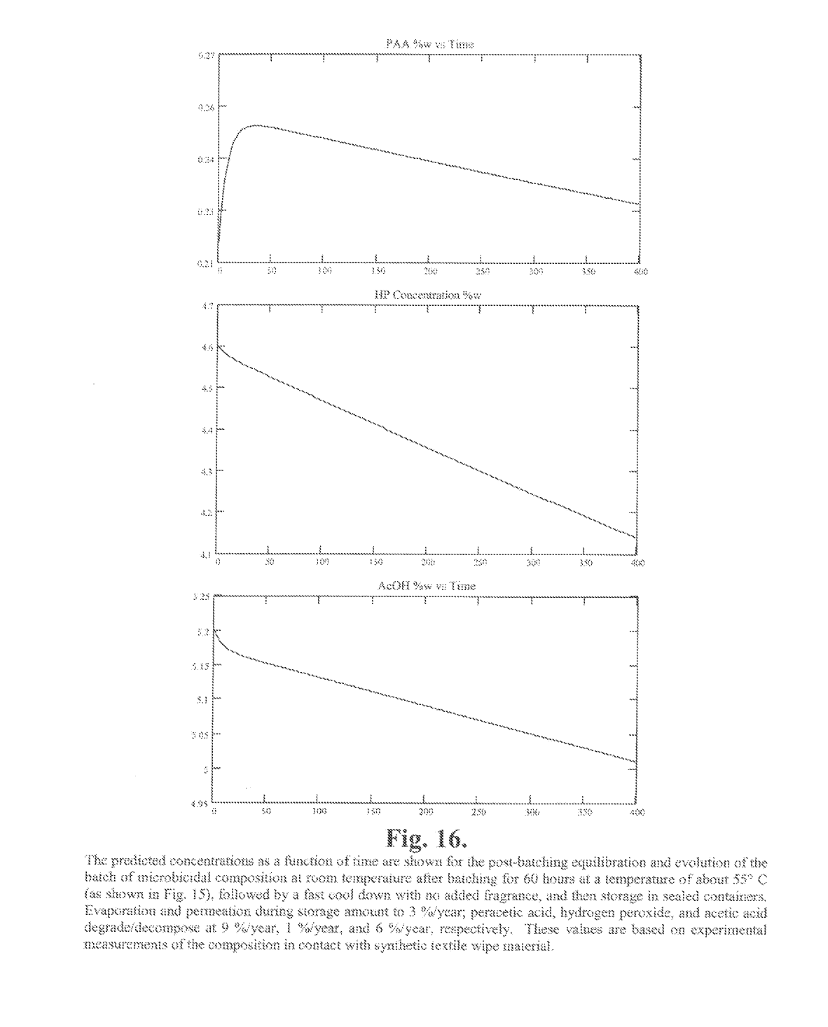

In FIG. 16, the predicted concentrations as a function of time are shown for the post-batching equilibration and evolution of the batch of microbicidal composition at room temperature after batching for 60 hours at a temperature of about 55° C. (as shown in FIG. 15), followed by a fast cool down with no added fragrance, and then storage in sealed containers. Evaporation and permeation during storage amount to 3%/year; peracetic acid, hydrogen peroxide, and acetic acid degrade/decompose at 9%/year, 12%/year, and 6%/year, respectively. These values are based on experimental measurements of the composition in contact with synthetic textile wipe material.

Microbicidal efficacy tests have been performed with three lots of microbicidal composition prepared according to the process of the instant invention. The nominal active ingredient concentrations were selected so that they would be representative of the lower half of the range between the certified limits for the composition of Example 1. For these tests, the hydrogen peroxide concentration was about 4.2% w/w, and the peracetic acid concentration was 0.20% w/w. The tests comprised several tests according to the AOAC Official Methods of Analysis and as required by the US EPA Disinfectant Technical Science Section (DIS/TSS) Guidelines. At least one of the lots of the composition used in the tests listed below was more than 60 days old at the time of testing. The tests included a soil load (typically, 5% soil), neutralization controls to demonstrate the success and reliability of the catalase/thiosulfate neutralization of the active ingredients at the end of the contact time, and experimental controls to determine recovered fraction of inoculum, titer concentration, and as applicable, to determine cytotoxicity, for example in the virucidal efficacy test. The tests that have been successfully passed when the composition was used as a ready-to-use microbicide with the listed contact times are listed in Table IV, below.

TABLE IV
Summary of Microbicidal Efficacy
of a Composition of a Preferred Embodiment

STERILANT
(45 minutes @ room temperature)
AOAC Sporicidal Activity Test
Bacillus subtilis
Clostridium sporogenes
DISINFECTANT
Bactericidal (2 minutes)
AOAC Germicidal Spray Test
Enterobacter aerogenes
Listeria monocytogenes
Pseudomonas aeruginosa
Salmonella typhimurium
Staphylococcus aureus
Vibrio cholerae
Salmonella enterica
Acinetobacter baumanii
Campylobacter jejuni
E. coli O157:H7
E. coli ESBL
Enterococcus faecalis- Vancomycin Resistant (VRE)
Enterococcus hirae
Haemophilus influenzae
Klebsiella pneumoniae
Legionella pneumophila
Proteus vulgaris
Serratia marcescens
Shigella sonnei
Staphylococcus aureus -MRSA
Community Acquired- Staphylococcus aureus (CA-MRSA)
Streptococcus pneumoniae- Penicilin Resistant (PRSP)
Streptococcus pyogenes
Tuberculocidal (5 minutes)
AOAC Tuberculocidal Activity Method
Mycobacterium bovis
Viricidal (2 minutes)
DIS/TSS-7 ASTM E1053-97
Avian Influenza A (H3N2)
Human Coronavirus (SARS)
Adenovirus
Influenza H5N1
Herpes simplex, Type 1
Herpes simplex, Type 2
Human Immunodeficiency type -1 (HIV-1)
Influenza A
Influenza B
Norovirus (F. Calicivirus)
Poliovirus type- 1
Reovirus
Respiratory syncytial virus (RSV)
Rhinovirus
Rotavirus
Sporicidal Activity of Disinfectant (7 minutes)
Standard Quantitative Disk Carrier Test
Clostridium difficile spores
Fungicidal/Mold Killing
(1 minute hard surfaces)
Fungicidal Germicidal Spray Method
Aspergillus niger
Candida albicans
Trichophyton mentagrophytes
SANITIZER
(30 seconds @ half-strength) on hard,
inanimate non-food contact surfaces:
Sanitizer Test for Inanimate Non-Food Contact DIS/TSS-10
Staphylococcus aureus
Klebsiella pneumoniae
(30 seconds @ half strength on pre-cleaned, food contact surfaces:
Germicidal and DetergentSanitizing Action of Disinfectants
DIS/TSS-4
Escherichia coli
Staphylococcus aureus

The tested microbicidal composition is expected to have Use Sites that will include the following: Disinfectant for use on hard, non-porous surfaces in: Hospitals and Health Care Facilities such as Clinics, Dental Offices, Hospices, Hospitals, Laboratories, Nursing Homes, Physical Therapy, Physician's Offices, Radiology, Rehabilitation, and Transport Vehicles, Critical Care Areas such as Critical Care Unit (CCU), Emergency Room, Intensive Care Unit (ICU), Neonatal Intensive Care Unit (NICU), Operating Room, Pediatric Intensive Care Unit (PICU), Surgery, and Emergency Medical Services, and Other Sites such as Schools, Colleges, Correctional Facilities, Hospitality Establishments such as Hotels, Motels, Cruise Ships, Veterinary Clinics, Animal Life Science Laboratories, Funeral Homes and Morgues, Research Laboratories, Industrial Facilities, Pharmaceutical Production Facilities, Cosmetic-Processing Facilities, Consumer Home Use, Dining Areas (non-food contact surfaces), Office Buildings, Recreational Facilities, Retail and Wholesale Establishments, Prisons, Animal Care Facilities, Veterinary Facilities, Farms, Livestock Quarters, Poultry Premises, Poultry Houses and Hatcheries, and vehicles including ships, planes, automobiles, trucks, ambulances, trains, and farm vehicles.

Typical items that can be treated by the tested microbicidal composition include the following: Hospital, Healthcare, and Critical Use Sites: May be used on hard non-porous surfaces of autoclaves, bed railings, blood glucose monitors, cabinets, carts, chairs, counters, exam tables, gurneys, isolettes, infant incubators and care cribs, Intravenous (IV) poles, phlebotomy trays, polyvinyl chloride (PVC) tubing, stethoscopes, stretchers, tables, bathrooms, sinks, faucets, toilet seats and rims, towel dispensers, hand railings, stall doors, bath tubs, showers, hampers, tiled walls, telephones, door knobs, vanities, floors, non-porous shelves, and display cases. Hard non-porous external surfaces include the following: ambulance equipment, diagnostic equipment, dialysis machines, mammography equipment, patient monitoring equipment, respiratory equipment, ultrasound transducers and probes, patient support and delivery equipment. The microbicidal composition is compatible with and in typical use will not harm aluminum, low density polyethylene (LDPE), HDPE, vinyl, painted surfaces, polycarbonate, polypropylene, polyurethane varnish, PVC, silicone rubber, stainless steel, medical tubing, vinyl rubber, acrylic, brass, LCD screens, copper, Corian®, glass, laminate flooring and countertops, nickel, polycarbonate, porcelain, glass, glazed tile, and many other materials.

Microbicidal efficacy tests have also been performed with compositions having lower concentrations of active ingredients than the composition of Examples 1 and 2. Tests with active ingredients being about 0.05% w/w peracetic acid and hydrogen peroxide about 1.0% w/w, which corresponds to a 4-fold dilution of the composition of Example 2, exhibited about 5.6 logs of killing of E. coli bacteria. Thus, in addition to comprising an RTU composition, the compositions of the instant invention may be diluted prior to use as an effective anti-microbial solution.

Further, the microbicidal compositions of Examples 1 and 2 have been found to be excellent for mold killing and mold remediation because they kill provide about 5 logs of killing of Aspergillus niger spores on porous surfaces such as textiles, nylon and polyolefin carpet, painted drywall, and painted/sealed masonry with a contact time of about 10 minutes and an application rate that is in the range of about 150 to about 300 mL/m² as sufficient to thoroughly wet the surface and contaminated pores of the material. For killing mold, it is further found that use of the composition in a step of cleaning the contaminated surface and removing deposits of mold and infested material, followed by the application of the composition by aerosol spraying, wiping, pouring, or other means, results in effective mold remediation. In an aspect of its use, the compositions provide significant reduction in odors associated with mold, bacteria, and other microbial infestations. It is also found that the compositions, when used as an aerosol spray, especially in conjunction with circulating or non-still air, dramatically remove undesirable odors. Use of the compositions containing fragrance results provides the aesthetic appeal of air-freshening.

Still further, it is found that the microbicidal compositions of the instant invention are excellent photosensitizers. With contact time T_{c}=one minute, and a subsequent illumination of about at least about 30 mJ/cm² fluence of UV light, killing of Bacillus atrophaeous spores to the level of detection, typically, about 6-7 logs of killing are obtained. Similarly, with T_{c}=3 min, and a fluence of at least about 30 mJ/cm² of UV light, killing of Bacillus subtilis spores to the level of detection, typically, about 6.5 logs of killing are obtained. Still further, the nucleic acid compounds, which include Deoxyribonucleic acid (DNA) and Ribonucleic acid (RNA), are substantially destroyed by such photosensitized UV treatment. The rapid and thorough killing and destruction of nucleic acid compounds are desirable attributes for uses in response and remediation to biological contamination after a bio-terrorism event or resulting from a natural disaster, such as a flood, and for tactical use by military forces or emergency or law enforcement responders. Effective killing is also obtained with the composition being used as a photosensitizer with a contact time of about 1 to about 3 minutes and the subsequent illumination by at least about 45 mJ/cm² fluence of visible light, although treatment without UV does not substantially destroy nucleic acid compounds. The teachings of this specification are representative examples, and as will be obvious to those practiced in the art, there are many variations in concentration and combinations of surfactants and polymers and peroxide and peracid compounds that will exhibit the photoactive behavior that enhances microbicidal efficacy.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed:

1. A method for the microbicidal treatment of a surface comprising the steps of:
applying a microbicidal composition to form a thin layer that wets said surface, wherein said microbicidal composition comprises:
hydrogen peroxide in concentration in a range of about 0.4 to 8% by weight,
peracetic acid in concentration in a range of about 0.02 to about 0.55% by weight,
acetic acid in concentration less that about 8% by weight,
phosphate ester surfactant in concentration in a range of about 0.01 to about 0.5% by weight,
water soluble polymer containing lactam in concentration in a range of about 0.01 to about 0.5% by weight,
less than 0.2% by weight of stabilizers selected from a group comprising inorganic phosphates, phosphonates, organic phosphonic acids or their salts, ethylenediaminetetracetic acid or its sodium salt,
less than about 1 ppm of mono- and divalent metal ions,
less than about 1 ppm of halide ions, and
a balance of water; and
contacting said surface with said microbicidal composition for a contact time that is greater than about 20% but less than or equal to 100% of an evaporation time of said thin layer, during said contact time said thin layer evaporating.

2. The method of claim 1, wherein said microbicidal composition further comprises less than 0.5% by weight of minors selected from a group comprising fragrance, colorant, and aesthetic enhancements.

3. The method of claim 1 further comprising:
illuminating said surface with light for photosensitized microbicidal effect.

4. The method of claim 1 further comprising:
rinsing said surface with clean water to substantially remove residue.

5. The method of claim 1 further comprising:
air-drying said surface.

6. The method of claim 1, wherein the step of applying said microbicidal composition is by a wipe that is wetted with said microbicidal composition just prior to use.

7. The method of claim 1, wherein the step of applying said microbicidal composition is by a packaged pre-wetted wipe with a ratio of a mass of said microbicidal composition and a mass of said wipe is in a range of 0.25 to about 10.

8. The method of claim 1 wherein in the step of contacting said surface with said microbicidal composition said contact time is about 100% of the evaporation time of said thin layer, and wherein the steps of applying said microbicidal composition and contacting said surface with said microbicidal composition are repeated one or more times.

9. The method of claim 3, wherein said surface is illuminated by ultraviolet light with a fluence of about 30 ml/cm² or greater for said photosensitized microbicidal effect.

10. The method of claim 1, wherein said thin layer has an initial thickness up to 150 μm.

11. The method of claim 1, wherein said thin layer has an initial thickness in a range of about 10 μm to 100 μm.

12. The method of claim 1, wherein said contact time is in a range of 25% to 70% of the said evaporation time.

13. A process for accurately making a batch of a microbicidal composition, wherein said batch of microbicidal composition comprises:
hydrogen peroxide in concentration in a range of about 2.0 to 6% by weight,
peracetic acid in concentration in a range of about 0.05 to about 0.74% by weight,
an equilibrium quantity of acetic acid,
phosphate ester surfactant in concentration in a range of about 0.025 to about 0.3% by weight,
water soluble polymer in concentration in a range of about 0.025 to about 0.3% by weight, and
a balance of water,
the resulting microbicidal composition having an equilibrium concentration quotient of about
$${K}_{c} \approx 1.4 exp [ 240.7 ( \frac{1}{T} - \frac{1}{293.2} ) ]$$
at a temperature T given in degrees Kelvin, wherein T is between about 283 and about 328 degrees Kelvin, and the mole fraction of water of the resulting microbicidal composition is greater than about 0.9,
said process comprising the steps of:
selecting target concentrations of hydrogen peroxide, peracetic acid, polymer, and surfactant in the resulting microbicidal composition at a selected batching temperature in a range of about 40° C. to about 55° C.;
calculating a target equilibrium concentration of acetic acid in the resulting microbicidal composition; and
selecting an initial concentration of peracetic acid

14. The process of claim 13, wherein said water soluble polymer contains lactam.

15. The process of claim 13, wherein said batch of microbicidal composition further comprises:
acid catalyst in concentration in the range of 0 to about 1000 ppm by weight,
less than 0.2% by weight of stabilizers selected from a group comprising inorganic phosphates, phosphonates, organic phosphonic acids or their salts, ethylenediaminetetracetic acid or its sodium salt,
less than about 1 ppm by weight of mono- and divalent metal ions,
less than about 1 ppm by weight of halide ions, and
less than 0.5% by weight of minors selected from the group of fragrance, colorant, and aesthetic enhancements.

16. The process of claim 15, further comprising:
determining by calculation that includes decomposition of peracetic acid into acetic acid and oxygen and an evaporation of water during the process, an amount of a diluted solution of a more concentrated solution of known composition comprising peracetic acid, hydrogen peroxide, acetic acid, acid catalyst, and water, an amount of glacial acetic acid, an amount of an aqueous solution of hydrogen peroxide, amounts of surfactant, polymer, and minors, and an amount of de-ionized/reverse osmosis filtered water to be added to the batch to obtain said target concentrations.

17. The process of claim 16, further comprising:
heating about 75% to about 100% of the said amount of de-ionized/reverse osmosis filtered water in a clean, passivated blending vessel to said selected batching temperature and continuously mixing contents of said vessel to limit spatial temperature variation of said contents to less than about 5° C.

18. The process of claim 17, further comprising:
adding the determined amount of water soluble polymer to and mixing with said heated water;
adding the determined amount of surfactant to and mixing with the contents of said vessel;
adding the determined amounts of hydrogen peroxide solution and glacial acetic acid to and mixing with the contents of said vessel;
adding the determined amount of peracetic acid solution to and mixing with the contents of said vessel; and
adding the determined amount of water to and mixing with the contents of said vessel.

19. The process of claim 18, further comprising:
maintaining the contents of said vessel at said batching temperature with less than about 5° C. spatial or temporal variation in the temperature of the contents for a batching time in a range of about 2 to 4 equilibration times.

20. The process of claim 19, further comprising:
measuring concentrations of hydrogen peroxide, and peracetic acid.

21. The process of claim 20, further comprising:
cooling the contents of the contents of said vessel to a desired temperature or to ambient temperature in a time that is much less than an equilibration time.

22. The process of claim 18, further comprising a step of:
adjusting the microbicidal composition of the blended mixture to obtain said target concentrations;

23. The process of claim 18, further comprising a step of:
adding one or more said minors to and mixing with the contents of said vessel;

24. The process of claim 21, further comprising a step of:
storing the resulting microbicidal composition in said vessel, or transferring the contents to another vessel, or transferring the contents to a product package, or transferring the contents as an ingredient in one or more products.

25. The process of claim 13 wherein the selection of said target concentrations is made so that during the year following the making of the batch, the concentration of peracetic acid in the resulting microbicidal composition remains within an upper limit and a lower limit that are within ±30% w/w of said target concentration and the concentration of hydrogen peroxide in the resulting microbicidal composition remains within an upper limit and a lower limit that are within ±10% w/w of said target concentration.

26. A microbicidal composition comprising:
hydrogen peroxide in concentration in a range of about 2.0 to 6% by weight,
peracetic acid in concentration in a range of about 0.05 to about 0.74% by weight,
an equilibrium quantity of acetic acid,
phosphate ester surfactant in concentration in a range of about 0.025 to about 0.3% by weight,
water soluble polymer in concentration in a range of about 0.025 to about 0.3% by weight, and
a balance of water,
the resulting microbicidal composition having an equilibrium concentration quotient of about
$$1.4 exp \{ 240.7 ( \frac{1}{T} - \frac{1}{293.2} ) \}$$
at a temperature T given in degrees Kelvin wherein T is between about 283 and about 328 degrees Kelvin, and the mole fraction of water of the said resulting microbicidal composition is greater than about 0.9.

27. The microbicidal composition of claim 26, wherein said soluble polymer contains lactam.

28. The microbicidal composition of claim 26, further comprising:
acid catalyst in concentration in a range of 0 to about 1000 ppm by weight,
less than 0.2% by weight of stabilizers selected from a group, comprising inorganic phosphates, phosphonates, organic phosphonic acids or their salts, ethylenediaminetetracetic acid or its sodium salt,
less than about 1 ppm by weight of mono- and divalent metal ions,
less than about 1 ppm by weight of halide ions, and
less than 0.5% by weight of minors selected from a group comprising fragrance, colorant, stabilizer, and aesthetic enhancements.

29. The microbicidal composition of claim 26, wherein the resulting microbicidal composition is made by a process for accurately making a batch of the microbicidal composition, the said process comprising the steps of:
selecting target concentrations of hydrogen peroxide, peracetic acid, polymer, and surfactant in the resulting microbicidal composition at a selected batching temperature in a range of about 40° C. to about 55° C.;
calculating target equilibrium concentration of acetic acid in the resulting microbicidal composition; and
selecting an initial concentration of peracetic acid, determining by calculation that includes decomposition of peracetic acid into acetic acid and oxygen and an evaporation of water during the batch process, an amount of a diluted solution of a more concentrated solution of known composition comprising from about 8% to about 25% w/w peracetic acid, about 10% to about 35% w/w hydrogen peroxide, from about 8% to about 28% w/w acetic acid, and water, an amount of glacial acetic acid, an amount of an aqueous solution of hydrogen peroxide, amounts of surfactant, polymer, and minors, and an amount of de-ionized/reverse osmosis filtered water to be added to the hatch to obtain the target concentrations.

30. The microbicidal composition of claim 29, wherein said process further comprising:
heating from about 75% to about 100% of an amount of de-ionized/reverse osmosis filtered water in a clean, passivated blending vessel to the selected botching temperature and continuously mixing the contents of said vessel to limit the spatial temperature variation of the contents to less than about 5° C.;
adding the determined amount of water soluble polymer to and mixing with said heated water;
adding the determined amount of surfactant to and mixing with the contents of said vessel;
adding the determined amounts of hydrogen peroxide solution and glacial acetic acid to and mixing with the contents of said vessel;
adding the determined amount of peracetic acid solution to and mixing with the contents of said vessel;
adding the remainder of the determined amount of water to and mixing with the contents of said vessel;
maintaining the contents of said vessel at the batching temperature with less than about 5° C. spatial or temporal variation in the temperature of the contents for a batching time in a range of about 2 to 4 equilibration times;
measuring the concentrations of hydrogen peroxide, and peracetic acid; and
cooling the contents of said vessel to a desired temperature or to ambient temperature in a time that is much less than an equilibration time,

31. The microbicidal composition of claim 30, wherein said process further comprises:
adjusting the composition of the blended mixture to obtain the target concentrations; and
adding one or more said minors to and mixing with the contents of said vessel;

32. The microbicidal composition of claim 30, wherein said process further comprises a step of:
storing the resulting microbicidal composition in said vessel, or transferring the contents to another vessel, or transferring the contents to a product package, or transferring the contents as an ingredient in one or more products.

33. The microbicidal composition of claim 26, wherein said microbicidal composition has a concentration of peracetic acid that remains within ±30% w/w of a desired nominal value in a range of about 0.05 and 0.74% w/w and a concentration of hydrogen peroxide that remains within ±10% w/w of a desired nominal value in a range of about 1 and 6% w/w for at least one year when stored within a temperature range of 10 to 30° C.

34. A use of the microbicidal composition of claim 26 as a photosensitizer for ultraviolet light activated microbicidal effect.
